(19) United States
(12) Patent Application Publication
(10) Pub. No.: US 2011/0257321 A1
(43) Pub. Date: Oct. 20, 2011

(54) HIGHLY BRANCHED POLYAMINES AND OLIGOAMINES AS CORROSION INHIBITORS

(75) Inventors: Maxim PERETOLCHIN, Mannheim (DE); Stephan Huffer, Munchen (DE); Guido Vandermeulen, Ilvesheim (DE)

(73) Assignee: BASF SE, Ludwigshafen (DE)

(21) Appl. No.: 13/087,934

(22) Filed: Apr. 15, 2011

Related U.S. Application Data
(60) Provisional application No. 61/324,767, filed on Apr. 16, 2010.

(51) Int. Cl. C09K 3/00; C08K 3/22; C08K 3/10; C08G 73/08

(52) U.S. Cl. 524/413; 525/540; 524/432

(57) ABSTRACT

The present invention relates to the use of highly branched polymers or oligomeric compounds prepared by condensing melamine (derivatives) and/or urea (derivatives) with diamines or polyamines for reducing or preventing the corrosion of corrosion-threatened materials. The invention further relates to a method for reducing, retarding or preventing the corrosion of corrsion-threatened materials, in which the materials and/or the corrosive medium to which the materials are exposed are or is contacted with at least one of these highly branched polymers and/or oligomers, and to an anti-corrosion composition which comprises these highly branched polymers and/or oligomers and also an anticorrosion pigment.

The present invention relates to the use of highly branched polymers or oligomeric compounds prepared by condensing melamine (derivatives) and/or urea (derivatives) with diamines or polyamines for reducing or preventing the corrosion of corrosion-threatened materials. The invention further relates to a method for reducing, retarding or preventing the corrosion of corrosion-threatened materials, in which the materials and/or the corrosive medium to which the materials are exposed are or is contacted with at least one of these highly branched polymers and/or oligomers, and to an anticorrosion composition which comprises these highly branched polymers and/or oligomers and also an anticorrosion pigment.

Corrosion is understood generally to be the reaction of a material with its environment, producing a measurable change in the material and possibly leading to impairment of the function of a component or of an entire system. In the majority of cases, the reaction is electrochemical in nature; in certain cases, it may be based on chemical or metallophysical processes. The term “corrosion” is used generally for metallic materials, but in its broader meaning also encompasses the changing of other materials, such as glass, plastics or building materials.

Corrosion causes considerable material and economic damage. Taking appropriate measures to protect materials under threat of corrosion is therefore often unavoidable. Among the anticorrosion measures, a distinction may be made between active and passive corrosion control. The active measures include, for example, the provision of a sacrificial anode or of an impressed-current anode; the reduction or prevention of contact between the corrosive medium and the material to be protected; the use of corrosion inhibitors; and the passivation of metal surfaces. Passive corrosion control refers in particular to the provision of a protective coat on the surface of the material to be protected, said coat preventing or at least considerably retarding, for example, the diffusion of the corrosive medium, such as water, oxygen or corrosion-promoting ions.

The protective coats may be metallic, inorganic-nonmetallic, or organic in nature. Metallic protective coats form a composite system with the materials to be protected, and are produced, for example, by plating, cladding or coating. Suitable metals depend on the material that is to be coated; in the case of steel as the material to be protected, for instance, use may be made of stainless steel, silver, nickel, copper, aluminum or alloys thereof. Examples of inorganic nonmetallic protective coats include enamel, silicon dioxide, graphite, metal oxides, metal carbides, phosphates, chromates, and oxalates. Organic protective coats are based on unsaturated polyesters, polyurethanes, vinyl esters or epoxy resins, for example.

Despite the very large selection of anticorrosion measures, there continues to be a need for anticorrosion agents, since many of the known measures have considerable disadvantages. For instance, the production of metal composite systems is very costly, inconvenient, and energy-intensive; the production of protective coats based on phosphates and chromates produces toxic waste waters, which have to be disposed of, at cost and effort; and many organic protective coats do not have sufficient mechanical or chemical resistance. The corrosion-retarding effect of inorganic protective coats based on silicon dioxide, which are used generally as a formulation with a styrene/acrylic acid copolymer binder, is also still in need of improvement.

It was an object of the present invention, therefore, to provide new anticorrosion compositions which at least partly overcome the disadvantages of the prior art and which are multifaceted in their possibilities for deployment.

Surprisingly, it has been found that highly branched polymers or oligomeric compounds formed by condensation of melamine (derivatives) and/or urea (derivatives) with diamines or polyamines reduce, retard or prevent the corrosion of materials under threat of corrosion. The compounds used in accordance with the invention develop their corrosion-inhibiting/corrosion-retarding effect via a number of mechanisms: thus they can be used not only for producing protective coats but also as corrosion inhibitors. They are also particularly suitable as binders for coating compositions based on silicon dioxide, in which they not only act as binders but also contribute to corrosion control.

The present invention accordingly provides for the use of condensation products selected from
(i) highly branched polymers obtainable by the condensation of
   (i-1) melamine and/or at least one melamine derivative; and
   (i-2) at least one amine having at least two primary amino groups that is different from melamine and from said at least one melamine derivative; and
   (i-3) optionally at least one further amine, which is different from components (i-1) and (i-2);
(ii) highly branched polymers obtainable by the condensation of
   (ii-1) urea and/or at least one urea derivative; and
   (ii-2) at least one amine having at least two primary and/or secondary amino groups, with at least one amine necessarily comprising at least three primary and/or secondary amino groups; and
   (ii-3) optionally at least one further amine, which is different from component (ii-2);
(iii) highly branched polymers obtainable by the condensation of
   (iii-1) melamine and/or at least one melamine derivative;
   (iii-2) urea and/or at least one urea derivative; and
   (iii-3) at least one amine having at least two primary amino groups that is different from melamine and from said at least one melamine derivative; and
   (iii-4) optionally at least one further amine, which is different from components (iii-1) and (iii-3);
(iv) oligomeric compounds, obtainable by the condensation of
   (iv-1) melamine and/or at least one melamine derivative; and
   (iv-2) at least one amine having at least two primary amino groups that is different from melamine and from said at least one melamine derivative; and
   (iv-3) optionally at least one further amine, which is different from components (iv-1) and (iv-2);
(v) oligomeric compounds, obtainable by the condensation of
   (v-1) urea and/or at least one urea derivative; and
   (v-2) at least one amine having at least two primary and/or secondary amino groups, with at least one amine necessarily comprising at least three primary and/or secondary amino groups; and
   (v-3) optionally at least one further amine, which is different from component (v-2); and
(vi) oligomeric compounds, obtainable by the condensation of
   (vi-1) melamine and/or at least one melamine derivative;
   (vi-2) urea and/or at least one urea derivative; and
   (vi-3) at least one amine having at least two primary amino groups that is different from melamine and from said at least one melamine derivative; and
   (vi-4) optionally at least one further amine, which is different from components (vi-1) and (vi-3);
      for reducing or preventing the corrosion of corrosion-threatened materials.

The invention also relates to a method for reducing, retarding or preventing the corrosion of corrosion-threatened materials, in which the materials and/or the corrosive medium to which the materials are exposed are or is contacted, preferably coated, with at least one of the highly branched polymers and/or oligomers as defined above.

In the context of the present invention the term “polymer” is understood broadly and encompasses addition polymers, polyadducts, and polycondensates—that is, it does not define the way in which the propagation of the chain proceeds. Most frequently in the present invention it identifies polycondensates.

By highly branched polymers are meant, in the context of the present invention, polymers having a branched structure and a high functionality, i.e., a high density of functional groups. For a general definition of highly branched polymers, refer to P. J. Flori, J. Am. Chem. Soc., 1952, 74, 2718, and H. Frey et al., Chem. Eur. J., 2000, 6, No. 14, 2499. They include star polymers, dendrimers, structurally and molecularly nonuniform highly branched polymers, and high molecular mass branched polymers different than these, such as comb polymers. Star polymers are polymers in which three or more chains extend out from one center. The center may be a single atom or a group of atoms. Dendrimers (cascade polymers) are molecularly uniform polymers having a highly symmetrical structure. In structural terms they derive from star polymers, with their chains branching again in a starlike manner. Dendrimers are prepared from small molecules by means of repeated reaction sequences. The number of monomer end groups grows exponentially with each reaction step and results in a spherical, treelike structure. On account of their uniform structure, dendrimers possess a uniform molecular weight.

In the context of the present invention it is preferred to use highly branched polymers which are different than dendrimers, i.e., which are both structurally and molecularly nonuniform (and hence do not have a uniform molecular weight, instead having a molecular weight distribution). Depending on reaction regime, they may be constructed on the one hand starting from a central molecule, in the same way as dendrimers, but with a nonuniform branch chain length. On the other hand, they may also extend out from linear molecules and be constructed with branched functional side groups.

“Highly branched” for the purposes of the present invention means, furthermore, that the degree of branching (DB) is 10% to 99.9%, preferably 20% to 99%, and more particularly from 20% to 95%. The degree of branching is the average number of dendritic links plus the average number of end groups per molecule, divided by the sum of average number of dendritic links, average number of linear links, and average number of end groups, multiplied by 100. By “dendritic” in this context is meant that the degree of branching at this point in the molecule is 99.9 to 100%. For the definition of the degree of branching, refer also to H. Frey et al., Acta Polym. 1997, 48, 30.

The highly branched polymers of the invention are substantially noncrosslinked. “Substantially noncrosslinked” or “noncrosslinked” in the sense of the present invention means that there is a degree of crosslinking of less than 15% by weight, preferably of less than 10% by weight, the degree of crosslinking being determined via the insoluble fraction of the polymer. The insoluble fraction of the polymer is determined, for example, by 4-hour extraction with the same solvent as used for the gel permeation chromatography (GPC), in other words preferably dimethylacetamide or hexafluoroisopropanol, depending on the solvent in which the polymer has the better solubility, in a Soxhlet apparatus, and by weighing the residue that remains after the extracted material has been dried to constant weight.

The highly branched polymers of the invention preferably have a number-average molecular weight Mₙ of at least 500, e.g., from 500 to 200 000 or preferably from 500 to 100 000 or more preferably from 500 to 50 000 or more preferably still from 500 to 30 000 or even more preferably from 500 to 20 000 or more particularly from 500 to 15 000; more preferably, of at least 1000, e.g., from 1000 to 200 000 or preferably from 1000 to 100 000 or more preferably from 1000 to 50 000 or more preferably still from 1000 to 30 000 or even more preferably from 1000 to 20 000 or more particularly from 1000 to 15 000; more preferably still, of at least 2000, e.g., from 2000 to 200 000 or preferably from 2000 to 100 000 or more preferably from 2000 to 50 000 or more preferably still from 2000 to 30 000 or even more preferably from 2000 to 20 000 or more particularly from 2000 to 15 000; and, more particularly, of at least 5000, e.g., from 5000 to 200 000 or preferably from 5000 to 100 000 or more preferably from 5000 to 50 000 or more preferably still from 5000 to 30 000 or even more preferably from 5000 to 20 000 or more particularly from 5000 to 15 000.

The highly branched polymers of the invention preferably have a number-average molecular weight Mₙ of at least 1000, e.g., from 1000 to 1 000 000 or preferably from 1000 to 500 000 or more preferably from 1000 to 300 000 or more preferably still from 1000 to 200 000 or especially from 1000 to 30 000; more preferably, of at least 2000, e.g., from 2000 to 1 000 000 or preferably from 2000 to 500 000 or more preferably from 2000 to 300 000 or more preferably still from 2000 to 200 000 or especially from 2000 to 30 000; more preferably still, of at least 5000, e.g., from 5000 to 1 000 000 or preferably from 5000 to 500 000 or more preferably from 5000 to 300 000 or more preferably still from 5000 to 200 000 or especially from 5000 to 30 000; and, more particularly, of at least 10 000, e.g., from 10 000 to 1 000 000 and preferably from 10 000 to 500 000 or more preferably from 10 000 to 300 000 or more preferably still from 10 000 to 200 000 or especially from 10 000 to 30 000.

The polydispersity (PD=M_{w}/Mₙ) is preferably in the range from 1.1 to 100, more preferably from 1.3 to 100, more preferably still from 1.5 to 50, and more particularly from 2 to 30.

The figures given in the context of the present invention for molecular weights (Mₙ, M_{w}) and for the polydispersity refer to data resulting from gel permeation chromatography (GPC) in a suitable solvent, such as hexafluoroisopropanol, tetrahydrofuran, N,N-dimethylacetamide or water, with PMMA calibration.

In contradistinction to the polymers the oligomeric compounds (oligomers) (iv), (v), and (vi) are low molecular mass products which are formed by the condensation of a few molecules, preferably 2, 3, 4 or 5 molecules, more preferably 2, 3 or 4 molecules, and have a defined molecular weight. For example, the oligomeric compounds (iv) come about through the condensation of a melamine molecule or melamine derivative molecule with one or two amine molecule(s), and the oligomeric compounds (v) come about, for example, through the condensation of a urea molecule or urea derivative molecule with one or with two amine molecule(s). The oligomeric compounds (vi) come about, for example, through the condensation of a melamine molecule or melamine derivative molecule with one, two or three amine molecule(s), and with a urea molecule or a urea derivative molecule.

Unless indicated otherwise, the following general definitions apply in the context of the present invention:

C₁-C₄-Alkyl stands for a linear or branched alkyl radical having 1 to 4 carbon atoms. These radicals are methyl, ethyl, n-propyl, isopropyl, n-butyl, sec-butyl, isobutyl, and tert-butyl.

Linear C₁-C₄-alkyl stands for a linear alkyl radical having 1 to 4 carbon atoms. These radicals are methyl, ethyl, n-propyl, and n-butyl.

C₂-C₆-Alkyl stands for a linear or branched alkyl radical having 2 to 6 carbon atoms. Examples are ethyl, n-propyl, isopropyl, n-butyl, sec-butyl, isobutyl, tert-butyl, pentyl, hexyl, and their constitutional isomers.

C₁-C₁₂-Alkyl stands for a linear or branched alkyl radical having 1 to 12 carbon atoms. Examples thereof are methyl, ethyl, n-propyl, isopropyl, n-butyl, sec-butyl, isobutyl, tertbutyl, pentyl, neopentyl, hexyl, heptyl, octyl, 2-ethylhexyl, nonyl, decyl, 2-propylheptyl, 4-methyl-2-propylhexyl, undecyl, dodecyl, and their constitutional isomers.

C₁-C₂₀-Alkyl stands for a linear or branched alkyl radical having 1 to 20 carbon atoms. Examples thereof, in addition to the radicals stated above for C₁-C₁₂-alkyl, are tridecyl, tetradecyl, pentadecyl, hexadecyl, heptadecyl, octadecyl, nonadecyl, eicosyl, and their constitutional isomers.

C₂-C₄-Alkyl stands for a linear or branched alkyl radical having 2 to 4 carbon atoms, in which one hydrogen atom has been replaced by a hydroxyl group. Examples thereof are 2-hydroxyethyl, 2- and 3-hydroxypropyl, 1-hydroxy-2-propyl, 2-, 3- and 4-hydroxybutyl, and the like.

C₂-C₁₀-Alkenyl stands for a linear or branched aliphatic radical having 2 to 10 carbon atoms and one C—C double bond. Examples thereof are ethenyl (vinyl), 1-propenyl, allyl (2-propenyl), 1-, 2- or 3-butenyl, 1-, 2-, 3- or 4-pentenyl, 1-, 2-, 3-, 4- or 5-hexenyl, 1-, 2-, 3-, 4-, 5- or 6-heptenyl, 1-, 2-, 3-, 4-, 6- or 7-octenyl, 1-, 2-, 3-, 4-, 5-, 6-, 7- or 8-nonenyl, 1-, 2-, 3-, 4-, 5-, 6-, 7-, 8- or 9-decenyl, and their constitutional isomers.

C₃-C₆-Cycloalkyl stands for a cycloaliphatic saturated radical having 3 to 6 carbon atoms. Examples thereof are cyclopropyl, cyclobutyl, cyclopentyl, and cyclohexyl.

Aryl stands for a carbocyclic aromatic radical having 6 to 14 carbon atoms, such as phenyl, naphthyl, anthracenyl or phenanthrenyl. Preferably aryl stands for phenyl or naphthyl and more particularly for phenyl.

Aryl-C₁-C₄-alkyl stands for C₁-C₄-alkyl, which is as defined above, with one hydrogen atom replaced by an aryl group. Examples are benzyl, phenethyl, and the like.

C₁-C₄-Alkoxy stands for a linear or branched alkyl radical having 1 to 4 carbon atoms that is attached via an oxygen atom. Examples thereof are methoxy, ethoxy, propoxy, isopropoxy, butoxy, sec-butoxy, isobutoxy, and tert-butoxy.

C₁-C₄-Alkylene is a linear or branched divalent alkyl radical having 1, 2, 3 or 4 carbon atoms. Examples are —CH₂—, —CH₂CH₂—, —CH(CH₃)—, —CH₂CH₂CH₂—, —CH(CH₃)CH₂—, —CH₂CH(CH₃)—, —C(CH₃)₂—, —CH₂CH₂CH₂CH₂—, —CH(CH₃)CH₂CH₂—, —CH₂CH₂CH(CH₃)—, —C(CH₃)₂CH₂—, —CH₂C(CH₃)₂—, and —CH₂CH₂CH₂CH₂CH₂—.

Linear C₁-C₄-alkylene is a linear divalent alkyl radical having 1, 2, 3 or 4 carbon atoms. Examples are —CH₂CH₂—, —CH₂CH₂CH₂—, and —CH₂CH₂CH₂CH₂—.

C₂-C₃-Alkylene is a linear or branched divalent alkyl radical having 2 or 3 carbon atoms. Examples are —CH₂CH₂—, —CH(CH₃)—, —CH₂CH₂CH₂—, —CH(CH₃)CH₂—, CH₂CH(CH₃)—, and —C(CH₃)₂—.

Linear or branched C₂-C₄-alkylene is a linear or branched divalent alkyl radical having 2, 3 or 4 carbon atoms. Examples are —CH₂CH₂—, —CH(CH₃)—, —CH₂CH₂CH₂—, —CH(CH₃)CH₂—, —CH₂CH(CH₃)—, —C(CH₃)₂—, —CH₂CH₂CH₂CH₂—, —CH(CH₃)CH₂CH₂—, —CH₂CH₂CH(CH₃)—, —C(CH₃)₂CH₂—, and —CH₂C(CH₃)₂—.

Linear C₂-C₄-alkylene is a linear divalent alkyl radical having 2, 3 or 4 carbon atoms. Examples are —CH₂CH₂—, —CH₂CH₂CH₂—, and —CH₂CH₂CH₂CH₂—.

Linear or branched C₂-C₅-alkylene is a linear or branched divalent alkyl radical having 2, 3, 4 or 5 carbon atoms. Examples are —CH₂CH₂—, —CH(CH₃)—, —CH₂CH₂CH₂—, —CH(CH₃)CH₂—, —CH₂CH(CH₃)—, —C(CH₃)₂—, —CH₂CH₂CH₂CH₂—, —CH(CH₃)CH₂CH₂—, —CH₂CH₂CH(CH₃)—, —C(CH₃)₂CH₂—, —CH₂C(CH₃)₂—, and —CH₂CH₂CH₂CH₂CH₂—.

Linear or branched C₂-C₆-alkylene is a linear or branched divalent radical having 2, 3, 4, 5 or 6 carbon atoms. Examples are —CH₂CH₂—, —CH(CH₃)—, —CH₂CH₂CH₂—, —CH(CH₃)CH₂—, —CH₂CH(CH₃)—, —C(CH₃)₂—, —CH₂CH₂CH₂CH₂—, —CH(CH₃)CH₂CH₂—, —CH₂CH₂CH(CH₃)—, —C(CH₃)₂CH₂—, —CH₂C(CH₃)₂—, —CH₂CH₂CH₂CH₂CH₂—, and —CH₂CH₂CH₂CH₂CH₂CH₂—.

Linear C₂-C₆-alkylene is a linear divalent alkyl radical having 2, 3, 4, 5 or 6 carbon atoms. Examples are —CH₂CH₂—, —CH₂CH₂CH₂—, —CH₂CH₂CH₂CH₂—, —CH₂CH₂CH₂CH₂CH₂—, and —CH₂CH₂CH₂CH₂CH₂CH₂—.

Linear or branched C₄-C₈-alkylene is a linear or branched divalent alkyl radical having 4 to 8 carbon atoms. Examples are —CH₂CH₂CH₂CH₂—, —CH(CH₃)CH₂CH₂—, —CH₂CH₂CH(CH₃)—, —C(CH₃)₂CH₂—, —CH₂C(CH₃)₂—, —CH₂CH₂CH₂CH₂CH₂—, —CH₂C(CH₃)₂CH₂—, —CH₂CH₂CH₂CH₂CH₂CH₂—, —(CH₂)₂—, —(CH₂)₈—, and positional isomers thereof.

Linear or branched C₄-C₁₀-alkylene is a linear or branched divalent alkyl radical having 4 to 10 carbon atoms. Examples, in addition to the radicals stated above for C₄-C₈-alkylene, are the higher homologs with 9 or 10 carbon atoms, such as nonylene and decylene.

Linear or branched C₂-C₁₀-alkylene is a linear or branched divalent alkyl radical having 2 to 10 carbon atoms. Examples, in addition to the radicals stated above for C₂-C₆-alkylene, are the higher homologs with 7 to 10 carbon atoms, such as heptylene, octylene, nonylene, and decylene.

Linear or branched C₁-C₁₀-alkylene is a linear or branched divalent alkyl radical having 1 to 10 carbon atoms. A further example, in addition to the radicals stated above for C₂-C₁₀-alkylene, is —CH₂—.

Linear or branched C₂-C₂₀-alkylene is a linear or branched divalent alkyl radical having 2 to 20 carbon atoms. Examples, in addition to the radicals stated above for C₂-C₅-alkylene, are the higher homologs having 6 to 20 carbon atoms, such as hexylene, heptylene, octylene, nonylene, decylene, undecylene, dodecylene, tridecylene, tetradecylene, pentadecylene, hexadecylene, heptadecylene, octadecylene, nonadecylene, and eicosylene.

Alkenylene is a linear or branched aliphatic, singly or multiply, e.g., singly or doubly, olefinically unsaturated divalent radical having for example 2 to 20 or 2 to 10 or 4 to 8 carbon atoms. If the radical contains more than one carbon-carbon double bond these bonds are preferably not vicinal, i.e., not allenic.

Alkynylene is a linear or branched aliphatic divalent radical having, for example, 2 to 20 or 2 to 10 or 4 to 8 carbon atoms and containing one or more, e.g., 1 or 2, carbon-carbon triple bonds.

C₈-C₈-Cycloalkylene stands for a divalent monocyclic, saturated hydrocarbon group having 5 to 8 carbon ring members. Examples are cyclopentane-1,2-diyl, cyclopentan-1,3-diyl, cyclohexane-1,2-diyl, cyclohexane-1,3-diyl, cyclohexane-1,4-diyl, cycloheptane-1,2-diyl, cycloheptane-1,3-diyl, cycloheptane-1,4-diyl, cyclooctane-1,2-diyl, cyclooctane-1,3-diyl, cyclooctane-1,4-diyl, and cyclooctane-1,5-diyl.

5- or 6-membered saturated, partly unsaturated or aromatic heterocycle comprising 1, 2 or 3 heteroatoms, selected from O, S, and N, as ring members stands, for example, for tetrahydrofuranyl, tetrahydrothienyl, pyrrolidinyl, pyrazolidinyl, imidazolidinyl, oxazolidinyl, isoxazolidinyl, thiazolidinyl, isothiazolidinyl, triazolidinyl, oxadiazolidinyl, thiadiazolidinyl, piperidinyl, tetrahydropyranyl, piperazinyl, morpholinyl, thiomorpholinyl; dihydrofuranyl, dihydrothienyl, pyrrolinyl, pyrazolinyl, imidazolinyl, oxazolinyl, isoxazolinyl, thiazolinyl, isothiazolinyl, triazolinyl, oxadiazolinyl, thiadiazolinyl, tetrahydropyridyl, dihydropyridyl, dihydropyranyl, pyranyl; furanyl, thienyl, pyrrolyl, pyrazolyl, imidazolyl, oxazolyl, isoxazolyl, thiazolyl, isothiazolyl, triazolyl, oxadiazolyl, thiadiazolyl, pyridyl, pyridazonyl, pyrimidyl, pyrazinyl, and triazinyl.

5- or 6-membered unsaturated nonaromatic heterocycle attached by N and possibly further comprising one or two further nitrogen atoms or one further sulfur atom or oxygen atom as ring member stands, for example, for pyrrolin-1-yl, pyrazolin-1-yl, imidazolin-1-yl, 2,3-dihydrooxazol-3-yl, 2,3- and 2,5-dihydroisoxazol-2-yl, 2,3-dihydrothiazol-3-yl, 2,3- and 2,5-dihydroisothiazol-2-yl, [1,2,4]-1H-triazolin-1-yl, [1,3,4]-1H-triazolin-1-yl, [1,2,3]-dihydropyridin-1-yl, 1,4-dihydropyridin-1-yl, 1,2,3,4-tetrahydropyridin-1-yl, 1,2-dihydropyridazin-1-yl, 1,4-dihydropyridazin-1-yl, 1,6-dihydropyridazin-1-yl, 1,2,3,4-tetrahydropyridazin-1-yl, 1,4,5,6-tetrahydropyridazin-1-yl, 1,2-dihydropyrimidin-1-yl, 1,4-dihydropyrimidin-1-yl, 1,6-dihydropyrimidin-1-yl, 1,2,3,4-tetrahydropyrimidin-1-yl, 1,4,5,6-tetrahydropyrimidin-1-yl, 1,2-dihydropyrazin-1-yl, 1,4-dihydropyrazin-1-yl, 1,2,3,4-tetrahydropyrazin-1-yl, 1,4-oxazin-4-yl, 2,3-dihydro-1-4-oxazin-4-yl, 2,3,5,6-tetrahydro-1-4-oxazin-4-yl, 1,4-thiazin-4-yl, 2,3-dihydro-1-4-thiazin-4-yl, 2,3,5,6-tetrahydro-1-4-thiazin-4-yl, 1,2-dihydro-1,3,5-triazin-1-yl, 1,2,3,4-tetrahydro-1,3,5-triazin-1-yl and the like.

5- or 6-membered unsaturated aromatic heterocycle attached via N and possibly further comprising a further nitrogen atom as ring member stands, for example, for pyrrol-1-yl, pyrazol-1-yl, imidazolyl-1-yl, and triazol-1-yl.

By a primary amino group is meant a radical —NH₂. By a secondary amino group is meant a radical —NHR, R being other than H.

The observations made above and below in relation to preferred embodiments of the inventive use, method, and anticorrosion composition, more particularly in relation to the condensation products employed in accordance with the invention and their parent monomers and further reaction components, and further constituents of the anticorrosion composition, apply not only individually per se but also, more particularly, in any conceivable combination with one another.

Melamine derivatives which are used optionally for preparing the polymers or oligomers (i), (iii), (iv) or (vi) as components (i-1), (iii-1), (iv-1) or (vi-1) are preferably selected from benzoguanamine, substituted melamines, and melamine condensates, and also mixtures thereof.

Substituted melamines are, for example, singly or doubly N-alkylated melamines, such as 2,4-diamino-6-methylamino-1,3,5-triazine, 2,4-diamino-6-dimethylamino-1,3,5-triazine, 2,4-di(methylamino)-6-amino-1,3,5-triazine, aminoalkyl-substituted melamines, such as N,N′,N″-tris(2-aminoethyl)melamine, N,N′,N″-tris(3-aminopropyl)melamine, N,N′,N″-tris(4-aminobutyl)melamine, N,N′,N″-tris(5-aminopentyl)melamine, and N,N′,N″-tris(6-aminohexyl)melamine and the like.

The melamine condensates are preferably selected from melam, melem, melon, and higher condensates. Melam (empirical formula C₆H₉N₁₁) is a dimeric condensation product of 2,4-diamino-6-chloro-s-triazine with melamine. Melem (empirical formula C₆H₆N₁₀) is the tri-s-triazine substituted by three amino groups (1,3,4,6,7,9,9b-heptaazaphenalene). Melon (empirical formula C₆H₃N₉) is likewise a heptazine.

As component (i-1), (iii-1), (iv-1) or (vi-1) it is preferred to use melamine, optionally in a mixture with at least one melamine derivative, i.e., the components (i-1), (iii-1), (iv-1) and (vi-1) preferably in each case comprise melamine. If melamine is used in a mixture with at least one melamine derivative, the weight ratio of melamine to the total amount of the at least one melamine derivative is preferably 1:2 to 1000:1, more preferably 1:1 to 500:1, and more particularly 2:1 to 100:1.

With particular preference, however, no melamine derivative is used as component (i-1), (iii-1), (iv-1) or (vi-1), but instead exclusively melamine.

The at least one amine having at least two primary and/or secondary amino groups, of components (ii-2) and (v-2), is preferably an amine having at least two primary amino groups.

The at least one amine having at least two primary amino groups, of components (i-2), (iii-3), (iv-2), and (vi-3), and also the at least one amine having at least two primary and/or secondary amino groups, of components (ii-2) and (v-2), is preferably selected from amines of the formula I

NH₂-A-NH₂ (I)

in which
A is a divalent aliphatic, alicyclic, aliphatic-alicyclic, aromatic or araliphatic radical, with the aforementioned radicals also possibly being interrupted by a carbonyl group or by a sulfone group and/or possibly substituted by 1, 2, 3 or 4 radicals selected from C₁-C₄-alkyl; or is a divalent radical of the formula

B—Xₘ—B—

in which
each X independently is O or NR^{c}, in which R^{c} is H, C₁-C₄-alkyl, C₂-C₄-hydroxyalkyl or C₁-C₄-alkoxy, preferably H or C₁-C₄-alkyl, more preferably H or methyl, and more particularly H;
each B independently is C₂-C₆-alkylene and preferably is C₂-C₃-alkylene; and
m is a number from 1 to 100.

Also suitable are mixtures of these amines.

Divalent aliphatic radicals are those which contain no cycloaliphatic, aromatic or heterocyclic constituents. Examples are alkylene, alkenylene, and alkynylene radicals.

Divalent alicyclic radicals may comprise one or more, e.g., one or two alicyclic radicals; however, they contain no aromatic or heterocyclic constituents. The alicyclic radicals may be substituted by aliphatic radicals, although binding sites for the two NH₂ groups are located on the alicyclic radical.

Divalent aliphatic-alicyclic radicals contain not only at least one divalent aliphatic radical but also at least one divalent alicyclic radical, the two binding sites of the two NH₂ groups possibly being located either both on the alicyclic radical(s) or both on the aliphatic radical(s) or one on an aliphatic radical and the other on an alicyclic radical.

Divalent aromatic radicals may comprise one or more, e.g., one or two aromatic radicals; however, they contain no alicyclic or heterocyclic constituents. The aromatic radicals may be substituted by aliphatic radicals, although both binding sites for the two NH₂ groups are located on the aromatic radical(s).

Divalent araliphatic radicals contain not only at least one divalent aliphatic radical but also at least one divalent aromatic radical, the two binding sites for the two NH₂ groups possibly being located either both on the aromatic radical(s) or both on the aliphatic radical(s), or one on an aliphatic radical and the other on an aromatic radical.

In one preferred embodiment, the divalent aliphatic radical A is linear or branched C₂-C₂₀-alkylene, more preferably linear or branched C₂-C₁₀-alkylene, and in particular linear or branched C₄-C₈-alkylene.

Examples of suitable amines in which the radical A has this definition (C₂-C₂₀-alkylene) are 1,2-ethylenediamine, 1,2- and 1,3-propylenediamine, 2,2-dimethyl-1,3-propanediamine, 1,4-butylenediamine, 1,5-pentylenediamine, hexamethylenediamine, heptamethylenediamine, octamethylenediamine, nonamethylenediamine, decamethylenediamine, undecamethylenediamine, dodecamethylenediamine, tridecamethylenediamine, tetradecamethylenediamine, pentadecamethylenediamine, hexadecamethylenediamine, heptadecamethylenediamine, octadecamethylenediamine, nonadecamethylenediamine, eicosamethylenediamine, 2-butyl-2-ethyl-1,5-pentamethylenediamine, 2,2,4- or 2,4,4-trimethyl-1,6-hexamethylenediamine, 1,5-diamino-2-methylpentane, 1,4-diamino-4-methylpentane, and the like.

Preferred among these are amines in which A is linear or branched C₂-C₁₀-alkylene, such as in 1,2-ethylenediamine, 1,2- and 1,3-propylenediamine, 2,2-dimethyl-1,3-propanediamine, 1,4-butylenediamine, 1,5-pentylenediamine, hexamethylenediamine, heptamethylenediamine, octamethylenediamine, nonamethylenediamine, decamethylenediamine, 2,2,4- or 2,4,4-trimethyl-1,6-hexamethylenediamine, 1,5-diamino-2-methylpentane, 1,4-diamino-4-methylpentane, and the like.

Particularly preferred among these are amines in which A is linear or branched C₄-C₈-alkylene, such as in 2,2-dimethyl-1,3-propanediamine, 1,4-butylenediamine, 1,5-pentylenediamine, hexamethylenediamine, heptamethylenediamine, octamethylenediamine, 1,5-diamino-2-methylpentane, 1,4-diamino-4-methylpentane, and the like. In one specific embodiment, amines are used in which A is linear or branched C₄-C₈-alkylene, with not more than one branch originating from one carbon atom in the branched alkylene. Examples of such amines are 1,4-butylenediamine, 1,5-pentylenediamine, hexamethylenediamine, heptamethylenediamine, octamethylenediamine, and 1,5-diamino-2-methylpentane, i.e., the amines cited above as being particularly preferred, with the exception of 2,2-dimethyl-1,3-propanediamine and 1,4-diamino-4-methylpentane. Even more specifically, amines are used in which A is linear C₄-C₅-alkylene, such as 1,4-butylenediamine, 1,5-pentylenediamine, hexamethylenediamine, heptamethylenediamine, and octamethylenediamine.

In one preferred embodiment, the divalent alicyclic radicals A are selected from C₅-C₈-cycloalkylene, which may carry 1, 2, 3 or 4 C₁-C₄-alkyl radicals.

Examples of suitable amines in which the radical A has this definition are cyclopentylenediamine, such as 1,2-diaminocyclopentane or 1,3-diaminocyclopentane, cyclohexylenediamine, such as 1,2-diaminocyclohexane, 1,3-diaminocyclohexane or 1,4-diaminocyclohexane, 1-methyl-2,4-diaminocyclohexane, 1-methyl-2,6-diaminocyclohexane, cycloheptylenediamine, such as 1,2-diaminocycloheptane, 1,3-diaminocycloheptane or 1,4-diaminocycloheptane, and cyclooctylenediamine, such as 1,2-diaminocyclooctane, 1,3-diaminocyclooctane, 1,4-diaminocyclooctan or 1,5-diaminocyclooctane. The amino groups (NH₂ groups) may be located cis or trans to one another.

In one preferred embodiment, the divalent aliphatic-alicyclic radicals A are selected from C₅-C₅-cycloalkylene-C₁-C₄-alkylene, C₅-C₈-cycloalkylene-C₁-C₄-alkylene-C₅-C₈-cycloalkylene and C₁-C₄-alkylene-C₅-C₈-cycloalkylene-C₁-C₄-alkylene, with the cycloalkylene radicals possibly carrying 1, 2, 3 or 4 C₁-C₄-alkyl radicals.

Examples of suitable amines in which the radical A has this definition are diaminodicyclohexylmethane, isophoronediamine, bis(aminomethyl)cyclohexane, such as 1,1-bis(aminomethyl)cyclohexane, 1,2-bis(aminomethyl)cyclohexane, 1,3-bis(aminomethyl)cyclohexane or 1,4-bis(aminomethyl)cyclohexane, 2-aminopropylcyclohexylamine, 3(4)-aminomethyl-1-methylcyclohexylamine and the like. The groups attached to the alicyclic radical may each occupy any desired relative position (cis/trans) to one another.

In one preferred embodiment, the divalent aromatic radicals A are selected from phenylene, biphenylene, naphthylene, phenylene-sulfone-phenylene, and phenylene-carbonyl-phenylene, with the phenylene and naphthylene radicals possibly carrying 1, 2, 3 or 4 C₁-C₄-alkyl radicals.

Examples of suitable amines in which the radical A has this definition are phenylenediamine, such as o-, m-, and p-phenylenediamine, tolylenediamine, such as o-, m-, and p-tolylenediamine, xylylenediamine, naphthylenediamine, such as 1,2-, 1,3-, 1,4-, 1,5-, 1,8-, 2,3-, 2,6-, and 2,7-naphthylene, diaminodiphenyl sulfone, such as 2,2′-, 3,3′-, and 4,4′-diaminodiphenyl sulfone, and diaminobenzophenone, such as 2,2′-, 3,3′-, and 4,4′-diaminobenzophenone.

In one preferred embodiment, the divalent araliphatic radicals A are selected from phenylene-C₁-C₄-alkylene and phenylene-C₁-C₄-alkylene-phenylene, with the phenylene radicals possibly carrying 1, 2, 3 or 4 C₁-C₄-alkyl radicals.

Examples of suitable amines in which the radical A has this definition are diaminodiphenylmethane, such as 2,2′-, 3,3′-, and 4,4′-diaminodiphenylmethane, and the like.

In one preferred embodiment, X is O. In this case, m is preferably a number from 2 to 100, preferably 2 to 80 and more particularly 2 to 20, e.g., 2 to 10 or 2 to 6.

Examples of suitable amines in which the radical A has this definition are amine-terminated polyoxyalkylene polyols, examples being Jeff-amines, such as 4,9-dioxadodecane-1,12-diamine and 4,7,10-trioxamidecane-1,13-diamine, or else more regular amine-terminated polyoxyalkylene polyols, such as amine-terminated polyethylene glycols, amine-terminated polypropylene glycols or amine-terminated polybutylene glycols. The three last-mentioned amines (amine-terminated polyalkylene glycols) preferably have a molecular weight of 200 to 3000 g/mol.

In one alternatively preferred embodiment, X is NR^{c}. In this case, R^{c} is preferably H or C₁-C₄-alkyl, more preferably H or methyl, and more particularly H. Each B here independently is, in particular, C₂-C₃-alkylene, such as 1,2-ethylene, 1,2-propylene, and 1,3-propylene, and more particularly 1,2-ethylene and 1,3-propylene. In this case, m is preferably a number from 1 to 20, more preferably from 1 to 10, even more preferably from 1 to 6, and more particularly from 1 to 4.

Examples of suitable amines in which the radical A has this definition are diethylenetriamine, triethylenetetramine, tetraethylenepentamine, pentaethylenehexamine, hexaethyleneheptamine, heptaethyleneoctamine, octaethylenenonamine, higher polyimines, bis(3-aminopropyl)amine, bis(3-aminopropyl)methylamine, N3-amine (3-(2-aminoethylamino)propylamine), N4-amine (N,N′-bis(3-aminopropyl)ethylenediamine), and the like.

With particular preference A in compounds I is a divalent aliphatic radical or is a radical of the formula B—Xₘ—B—, in which B, X, and m have one of the general definitions indicated above or, more particularly, one of the preferred definitions indicated above.

With preference in this case the divalent aliphatic radical is selected from linear or branched C₂-C₁₀-alkylene, more preferably from linear or branched C₄-C₈-alkylene, and more particularly from linear C₄-C₈-alkylene;

and, in the radical of the formula B—Xₘ—B—
each X independently is NR^{c}, in which R^{c} is as defined above and is preferably H or C₁-C₄-alkyl, more preferably H or methyl and more particularly H;
each B independently is C₂-C₃-alkylene and preferably 1,2-ethylene or 1,3-propylene; and
m is a number from 1 to 20, preferably from 1 to 10, more preferably from 1 to 6, and more particularly from 1 to 4.

In compounds I, A is selected more particularly from
linear C₄-C₈-alkylene; and
the radical of the formula B—Xₘ—B—, in which
   X is NH;
   each B independently is 1,2-ethylene or 1,3-propylene; and
   m is a number from 1 to 10, preferably from 1 to 6, and more particularly from 1 to 4.

With particular preference, the at least one amine having at least two primary amino groups, of components (i-2), (iii-3), (iv-2), and (vi-3), and also the at least one amine having at least two primary and/or secondary amino groups, of components (ii-2) and (v-2), is selected from amines of the formula I in which A is a radical of the formula B—Xₘ—B—, in which B, X, and m have one of the general definitions indicated above or, more particularly, one of the preferred definitions indicated above, and mixtures thereof with amines of the formula I in which A is a divalent aliphatic radical, in which the divalent aliphatic radical has one of the general definitions indicated above or, more particularly, one of the preferred definitions indicated above.

With greater preference, the at least one amine having at least two primary amino groups, of components (i-2), (iii-3), (iv-2), and (vi-3), and also the at least one amine having at least two primary and/or secondary amino groups, of components (ii-2) and (v-2), is selected from amines of the formula I, in which A is a radical of the formula B—Xₘ—B—, in which each B independently is 1,2-ethylene or 1,3-propylene; X is NH; and m is a number from 1 to 10, preferably from 1 to 6, and more particularly from 1 to 4, and mixtures thereof with amines of the formula I in which A is linear C₄-C₈-alkylene.

More particularly, the at least one amine having at least two primary amino groups, of components (i-2), (iii-3), (iv-2), and (vi-3), and also the at least one amine having at least two primary and/or secondary amino groups, of components (ii-2) and (v-2), is selected from 1,2-ethylenediamine, 1,3-propylenediamine, 1,4-butylenediamine, 1,5-pentylenediamine, hexamethylenediamine, heptamethylenediamine, octamethylenediamine, diethylenetriamine, triethylenetetramine, tetraethylenepentamine, pentaethylenehexamine, hexaethyleneheptamine, heptaethyleneoctamine, octaethylenenonamine, higher polyimines, bis(3-aminopropyl)amine, bis(3-aminopropyl)methylamine, N3-amine (3-(2-aminoethylamino)propylamine), N4-amine (N,N′-bis(3-aminopropyl)ethylenediamine), and mixtures thereof.

Specifically, the at least one amine having at least two primary amino groups, of components (i-2), (iii-3), (iv-2), and (vi-3), and also the at least one amine having at least two primary and/or secondary amino groups, of components (ii-2) and (v-2), is selected from diethylenetriamine, triethylenetetramine, tetraethylenepentamine, pentaethylenehexamine, hexaethyleneheptamine, heptaethyleneoctamine, octaethylenenonamine, higher polyimines, bis(3-aminopropyl)amine, bis(3-aminopropyl)methylamine, N3-amine (3-(2-aminoethylamino)propylamine), N4-amine (N,N′-bis(3-aminopropyl)ethylenediamine), and mixtures thereof, and also mixtures of at least one of these polyamines with at least one diamine selected from 1,2-ethylenediamine, 1,3-propylenediamine, 1,4-butylenediamine, 1,5-pentylenediamine, hexamethylenediamine, heptamethylenediamine, and octamethylenediamine.

Even more specifically, the at least one amine having at least two primary amino groups, of components (i-2), (iii-3), (iv-2), and (vi-3), and at least one amine having at least two primary and/or second amino groups, of components (ii-2) and (v-2), is selected from diethylenetriamine, triethylenetetramine, tetraethylenepentamine, pentaethylenehexamine, N3-amine (3-(2-aminoethylamino)propylamine), N4-amine (N,N′-bis(3-aminopropyl)ethylenediamine), and mixtures thereof, and also mixtures of at least one of these polyamines with at least one diamine selected from 1,4-butylenediamine, 1,5-pentylenediamine, hexamethylenediamine, heptamethylenediamine, and octamethylenediamine.

Said at least one amine having at least three primary and/or secondary amino groups, of components (ii-2) and (v-2), is preferably selected from
amines of the formula I.a

NHR^{a1}-A¹-NHR^{b1} (I.a)
in which
A¹ is a divalent radical of the formula

B¹—X¹ₘ₁—B¹—
in which
each X¹ independently is O or NR^{c1}, with at least one X¹ in the compound I.a being NR^{c1}, in which R^{c1} is H, C₁-C₄-alkyl, C₂-C₄-hydroxyalkyl or C₁-C₄-alkoxy, with at least one radical R^{c1} being H;
each B¹ independently is C₂-C₆-alkylene; and
m¹ is a number from 1 to 20; and
R^{a1} and R^{b1} independently of one another are H, C₁-C₄-alkyl, C₂-C₄-hydroxyalkyl or C₁-C₄-alkoxy;
   amines of the formula II

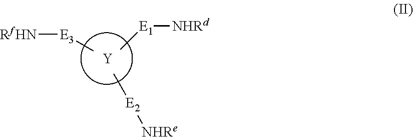

in which
Y is CR^{g}, N, C₂-C₆-alkyl, C₃-C₆-cycloalkyl, phenyl or a 5- or 6-membered, saturated, partly unsaturated or aromatic heterocyclic ring having 1, 2 or 3 heteroatoms as ring members which are selected from N, O, and S;
E₁, E₂, and E₃ independently of one another are a single bond, C₁-C₁₀-alkylene, NR^{h}—C₂-C₁₀-alkylene or O—C₁-C₁₀-alkylene, with the proviso that E₁, E₂, and E₃ are not a single bond and not NR^{h}—C₂-C₁₀-alkylene if Y is N;
R^{d}, R^{e} and R^{f} independently of one another are H, C₁-C₄-alkyl, C₂-C₄-hydroxyalkyl or C₁-C₄-alkoxy; and
R^{g} and R^{h} independently of one another are H, C₁-C₄-alkyl, C₂-C₄-hydroxyalkyl or C₁-C₄-alkoxy;
   amines of the formula III

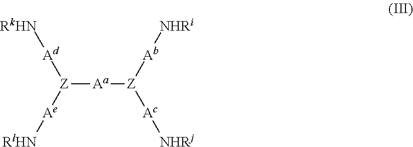

in which
A^{a} has one of the definitions stated for A in any one of claims 5 to 11;
A^{b}, A^{c}, A^{d}, and A^{e} independently of one another are C₁-C₁₀-alkylene;
Z is N or CR^{m}; and
Rⁱ, R^{j}, R^{k}, R^{l}, and R^{m} independently of one another are H, C₁-C₄-alkyl, C₂-C₄-hydroxyalkyl or C₁-C₄-alkoxy; and
   mixtures thereof.

In compounds I.a, preferably, all radicals X¹ are NR^{c1}.

Subject to the above proviso, R^{c1} is preferably H or C₁-C₄-alkyl, more preferably H, methyl or ethyl, and more particularly H.

B¹ is preferably C₂-C₃-alkylene, such as 1,2-ethylene, 1,2-propylene, and 1,3-propylene, and more particularly 1,2-ethylene or 1,3-propylene. m¹ is preferably a number from 1 to 10, more preferably from 1 to 6, and more particularly from 1 to 4.

Examples of suitable amines of the formula I.a are diethylenetriamine, triethylenetetramine, tetraethylenepentamine, pentaethylenehexamine, hexaethyleneheptamine, heptaethyleneoctamine, octaethylenenonamine, higher polyimines, bis(3-aminopropyl)amine, bis(3-aminopropyl)methylamine, N4-amine, and the like.

In compounds II, when Y is N, E₁, E₂, and E₃ are not a single bond and are not —NR^{h}—C₂-C₁₀-alkylene. If Y is N, then E₁, E₂ and E₃ are preferably also not methylene (C₁-alkylene). Where Y is CR^{g}, preferably at least two of the groups E₁, E₂, and E₃ are not a single bond.

If Y is a 5- or 6-membered, saturated, partially unsaturated or aromatic heterocyclic ring, then the three arms -E₁-NHR^{d}, -E₂-NHR^{e}, and -E₃-NHR^{f} may be attached both to carbon ring atoms and to nitrogen ring atoms of the heterocycle Y. If the arms -E₁-NHR^{d}, -E₂-NHR^{e}, and -E₃-NHR^{f} are attached to ring nitrogen atoms, then E₁, E₂ and E₃ are not a single bond and are not —NR^{h}—C₂-C₁₀-alkylene. The arms are preferably attached to different ring atoms of heterocycle Y. The heterocyclic ring Y is preferably selected from 5- or 6-membered heteroaromatic rings having 1, 2 or 3 nitrogen atoms as ring members. Examples of such hetaryl rings are pyrrolyl, pyrazolyl, imidazolyl, pyridyl, pyrimidyl, pyrazinyl, pyridazonyl, and triazinyl. More greatly preferred among these are 6-membered hetaryl rings, such as pyridyl, pyrimidyl, pyrazinyl, pyridazinyl, and triazinyl, with triazinyl being particularly preferred.

If Y is a triazine ring, then compound II is preferably melamine (Y=triazine-2,4,6-triyl; E₁, E₂, and E₃=single bond; R^{d}, R^{e}, and R^{f}=H) or aminoalkyl-substituted melamine (Y=1,3,5-triazine-2,4,6-triyl; E₁, E₂, and E₃=NR^{h}—C₂-C₁₀-alkylene, preferably NR^{h}—C₂-C₆-alkylene, where R^{h} is preferably H; R^{d}, R^{e}, R^{f}=preferably H), such as N,N′,N″-tris(2-aminoethyl)melamine, N,N′,N″-tris(3-aminopropyl)melamine, N,N′,N″tris(4-aminobutyl)melamine, N,N′,N″-tris(5-aminopentyl)melamine, and N,N′,N″-tris(6-aminohexyl)melamine.

The compounds III are amines having at least four primary and/or secondary amino functions.

In compounds III, A^{a} preferably has one of the definitions indicated as preferred for A. More particularly, A^{a} is C₂-C₆-alkylene, more preferably linear C₂-C₆-alkylene, such as 1,2-ethylene, 1,3-propylene, 1,4-butylene, pentamethylene, and hexamethylene.

Z is preferably N.

A^{b}, A^{c}, A^{d}, and A^{e} are preferably C₂-C₆-alkylene, more preferably linear C₂-C₆-alkylene, such as 1,2-ethylene, 1,3-propylene, 1,4-butylene, pentamethylene and hexamethylene, and more particularly are linear C₂-C₄-alkylene, such as 1,2-ethylene, 1,3-propylene, and 1,4-butylene.

Rⁱ, R^{j}, R^{k}, R^{l}, and R^{m} are preferably H.

Examples of amines having at least three primary and/or secondary amino groups, of the formulae I.a, II, and III, are diethylenetriamine, triethylenetetramine, tetraethylenepentamine, pentaethylenehexamine, hexaethyleneheptamine, heptaethyleneoctamine, octaethylenenonamine, higher polyimines, e.g., polyethyleneimines and polypropyleneimines, bis(3-aminopropyl)amine, bis(4-aminobutyl)amine, bis(5-aminopentyl)amine, bis(6-aminohexyl)amine, N4-amine, 3-(2-aminoethyl)aminopropylamine, N,N-bis(3-aminopropyl)ethylenediamine, N′,N-bis-(3-aminopropyl)ethylenediamine, N,N-bis(3-aminopropyl)propane-1,3-diamine, N,N-bis(3-aminopropyl)butane-1,4-diamine, N,N′-bis(3-aminopropyl)propane-1,3-diamine, N,N′-bis(3-aminopropyl)butane-1,4-diamine, N,N,N′N′-tetra(3-aminopropyl)ethylenediamine, N,N,N′,N′-tetra(3-aminopropyl)-1,4-butylenediamine, tris(2-aminoethyl)amine, tris(2-aminopropyl)amine, tris(3-aminopropyl)amine, tris(2-aminobutyl)amine, tris(3-aminobutyl)amine, tris(4-aminobutyl)amine, tris(5-aminopentyl)amine, tris(6-aminohexyl)amine, trisaminohexane, trisaminononane, 4-aminomethyl-1,8-octamethylenediamine, amine-terminated polyoxyalkylenepolyols having a functionality of three or more (e.g., Jeffamines, examples being Polyetheramin T403 or Polyetheramin T5000) having a molecular weight of preferably 300 to 10 000, melamine, aminoalkyl-substituted melamines, such as N,N′,N″-tris(2-aminoethyl)melamine, N,N′,N″-tris(3-aminopropyl)melamine, N,N,N″-tris(4-aminobutyl)melamine, N,N′,N″-tris(5-aminopentyl)melamine, and N,N′,N″-tris(6-aminohexyl)melamine, and oligomeric diaminodiphenylmethanes (polymeric-MDA).

Particularly preferred amines having at least three primary and/or secondary amino groups are selected from amines of the formula I.a, amines of the formula II, and mixtures thereof.

Preferred amines of the formula I.a are diethylenetriamine, triethylenetetramine, tetraethylenepentamine, pentaethylenehexamine, hexaethyleneheptamine, heptaethyleneoctamine, octaethylenenonamine, higher polyimines, e.g., polyethyleneimines and polypropyleneimines, bis(3-aminopropyl)amine, bis(4-aminobutyl)amine, bis(5-aminopentyl)amine, bis(6-aminohexyl)amine, 3-(2-aminoethyl)aminopropylamine, N′,N-bis(3-aminopropyl)ethylenediamine, N,N′-bis(3-aminopropyl)propane-1,3-diamine, and N,N′-bis(3-aminopropyl)butane-1,4-diamine.

Preferred amines of the formula II are those in which Y is N or is a 1,3,5-triazine-2,4,6-triyl ring.

Preferred amines II in which Y is N are selected from N,N-bis(3-amino-propyl)ethylenediamine, N,N-bis(3-aminopropyl)propane-1,3-diamine, N,N-bis(3-aminopropyl)butane-1,4-diamine, tris(2-aminoethyl)amine, tris(2-aminopropyl)amine, tris(3-aminopropyl)amine, tris(2-aminobutyl)amine, tris(3-aminobutyl)amine, tris(4-aminobutyl)amine, tris(5-aminopentyl)amine, and tris(6-aminohexyl)amine.

Preferred amines II in which Y is a 1,3,5-triazine-2,4,6-triyl ring are melamine and aminoalkyl-substituted melamines, such as N,N′,N″-tris(2-aminoethyl)melamine, N,N′,N″-tris(3-aminopropyl)melamine, N,N,N″-tris(4-aminobutyl)melamine, N,N′,N″-tris(5-aminopentyl)melamine, and N,N′,N″-tris(6-aminohexyl)melamine.

On account of the greater reactivity of primary amino functions —NH₂ in condensation reactions, the at least one amine having at least three primary and/or secondary amino groups, of components (ii-2) and (v-2), is preferably selected from amines having at least three primary amino groups. Accordingly, in compounds I.a, the radicals R^{a1}, R^{b1}, and R^{c1} are preferably H, and also, in compounds II, the radicals R^{d}, R^{e}, and R^{f} are preferably H. Analogously, in compounds III, the radicals Rⁱ, R^{j}, R^{k}, and R^{l} are preferably H. With regard to suitable and preferred amines having at least three primary amino groups, reference is made to the enumerations above (all aforementioned examples are amines having at least three primary amino groups).

The urea derivatives of components (ii-1), (iii-2), (v-1), and (vi-2) are preferably selected from
substituted ureas of the formula R¹R²N—C(═O)—NR³R⁴, in which R¹, R², R³, and R⁴ independently of one another are selected from hydrogen, C₁-C₁₂-alkyl, aryl, and aryl-C₁-C₄-alkyl, with at least one of the radicals R¹, R², R³, and R⁴ not being hydrogen;
or R¹ and R² and/or R³ and R⁴ each together are C₂-C₅-alkylene, with one methylene group (i.e., a CH₂ group in the alkylene chain) optionally being replaced by a carbonyl group;
or R¹ and R³ together are C₂-C₅-alkylene, with one methylene group (i.e., a CH₂ group in the alkylene chain) optionally being replaced by a carbonyl group;
or R¹ and R² and/or R³ and R⁴, in each case together with the nitrogen atom to which they are attached, form a 5- or 6-membered unsaturated aromatic or nonaromatic ring which may comprise one or two further nitrogen atoms or a sulfur atom or oxygen atom as ring member (i.e., R¹ and R², and/or R³ and R⁴, together with the nitrogen atom to which they are attached, stand for a 5- or 6-membered unsaturated aromatic or nonaromatic ring which is attached via N and may comprise one or two further nitrogen atoms or one sulfur atom or oxygen atom as ring member);
biuret
thiourea;
substituted thioureas of the formula R⁵R⁶N—C(═S)—NR⁷R⁸, in which R⁵, R⁶, R⁷, and R⁸ independently of one another are selected from hydrogen, C₁-C₁₂-alkyl, aryl, and aryl-C₁-C₄-alkyl, with at least one of the radicals R⁵, R⁶, R⁷, and R⁸ not being hydrogen;
or R⁵ and R⁶ and/or R⁷ and R⁸ each together are C₂-C₅-alkylene, with one methylene group (i.e., a CH₂ group in the alkylene chain) optionally being replaced by a carbonyl group;
or R⁵ and R⁷ together are C₂-C₅-alkylene, with one methylene group (i.e., a CH₂ group in the alkylene chain) optionally being replaced by a carbonyl group;
or R⁵ and R⁶ and/or R⁷ and R⁸, in each case together with the nitrogen atom to which they are attached, form a 5- or 6-membered unsaturated aromatic or nonaromatic ring which may comprise one or two further nitrogen atoms or a sulfur atom or oxygen atom as ring member (i.e., R⁵ and R⁶, and/or R⁷ and R⁸, together with the nitrogen atom to which they are attached, stand for a 5- or 6-membered unsaturated aromatic or nonaromatic ring which is attached via N and may comprise one or two further nitrogen atoms or one sulfur atom or oxygen atom as ring member);
guanidine;
substituted guanidines of the formula R⁹R¹⁰N—C(═NR¹¹)—NR¹²R¹³, in which R⁹, R¹⁰, R¹¹, R¹², and R¹³ independently of one another are selected from hydrogen, C₁-C₁₂-alkyl, aryl, and aryl-C₁-C₄-alkyl, with at least one of the radicals R⁹, R¹⁰, R¹¹, R¹², and R¹³ not being hydrogen;
or R⁹ and R¹⁰ and/or R¹² and R¹³ each together are C₂-C₅-alkylene, with one methylene group (i.e., a CH₂ group in the alkylene chain), optionally being replaced by a carbonyl group;
or R⁹ and R¹² together are C₂-C₅-alkylene, with one methylene group (i.e. a CH₂ group in the alkylene chain), optionally being replaced by a carbonyl group;
or R⁹ and R¹⁰ and/or R¹² and R¹³, in each case together with the nitrogen atom to which they are attached, form a 5- or 6-membered unsaturated aromatic or nonaromatic ring which may further comprise one further nitrogen atom, sulfur atom or oxygen atom as ring member (i.e., R⁹ and R¹⁰, and/or R¹² and R¹³, together with the nitrogen atom to which they are attached, stand for a 5- or 6-membered unsaturated aromatic or nonaromatic ring which is attached via N and may comprise one or two further nitrogen atoms or one sulfur atom or oxygen atom as ring member); and
carbonic esters of the formula R¹⁴—O—CO—O—R¹⁵, in which R¹⁴ and R¹⁵ independently of one another are selected from C₁-C₁₂-alkyl, aryl, and aryl-C₁-C₄-alkyl, or R¹⁴ and R¹⁵ together are C₂-C₅-alkylene.

It is of course also possible to use mixtures of different urea derivatives.

In one preferred embodiment, in the substituted ureas, R² and R⁴ are hydrogen and R¹ and R³ are alike or different and are C₁-C₁₂-alkyl, aryl or aryl-C₁-C₄-alkyl. Examples thereof are N,N′-dimethylurea, N,N′-diethylurea, N,N′-dipropylurea, N,N′-diisopropylurea, N,N′-di-n-butylurea, N,N′-diisobutylurea, N,N′-di-sec-butylurea, N,N′-di-tert-butylurea, N,N′-dipentylurea, N,N′-dihexylurea, N,N′-diheptylurea, N,N′-dioctylurea, N,N′-didecylurea, N,N′-didodecylurea, N,N′-diphenylurea, N,N′-dinaphthylurea, N,N′-ditolylurea, N,N′-dibenzylurea, N-methyl-N′-phenylurea, and N-ethyl-N′-phenylurea.

In an alternatively preferred embodiment R¹, R², R³, and R⁴ are alike and are linear C₁-C₄-alkyl. Examples thereof are N,N,N′,N′-tetramethylurea and N,N,N′N′-tetraethylurea.

In an alternatively preferred embodiment R¹ and R² and also R³ and R⁴ each together are C₂-C₅-alkylene, with one methylene group (CH₂) in the alkylene chain possibly being replaced by a carbonyl group (CO); that is, R¹ and R² together form a C₂-C₅-alkylene group in which a methylene group (CH₂) in the alkylene chain may be replaced by a carbonyl group (CO), and R³ and R⁴ together form a C₂-C₅-alkylene group in which a methylene group (CH₂) in the alkylene chain may be replaced by a carbonyl group (CO). Examples thereof are di(tetrahydro-1H-pyrrol-1-yl)methanone, bis(pentamethylene)urea and carbonylbiscaprolactam.

In an alternatively preferred embodiment R² and R⁴ are hydrogen and R¹ and R³ together form a C₂-C₅-alkylene group, with a methylene group possibly being replaced by a carbonyl group. Examples thereof are ethyleneurea and also 1,2- or 1,3-propyleneurea.

In an alternatively preferred embodiment R¹ and R² and also R³ and R⁴ each together with the nitrogen atom to which they are attached form an unsaturated aromatic or nonaromatic heterocycle as defined above. Examples thereof are carbonyldipyrazole and carbonyldiimidazole.

In one preferred embodiment, in the substituted thioureas, R⁶ and R⁸ are hydrogen and R⁵ and R⁷ are alike or different and are C₁-C₁₂-alkyl, aryl or aryl-C₁-C₄-alkyl. Examples thereof are N,N′-dimethylthiourea, N,N′-diethylthiourea, N,N′-dipropylthiourea, N,N′-diisopropylthiourea, N,N′-di-n-butylthiourea, N,N′-diisobutylthiourea, N,N′-di-sec-butylthiourea, N,N′-di-tert-butylthiourea, N,N′-dipentylthiourea, N,N′-dihexylthiourea, N,N′-diheptylthiourea, N,N′-dioctylthiourea, N,N′-didecylthiourea, N,N′-didodecylthiourea, N,N′-diphenylthiourea, N,N′-dinaphthylthiourea, N,N′-ditolylthiourea, N,N′-dibenzylthiourea, N-methyl-N′-phenylthiourea, and N-ethyl-N′-phenylthiourea.

In an alternatively preferred embodiment R⁵, R⁶, R⁷, and R⁸ are alike and are linear C₁-C₄-alkyl. Examples thereof are N,N,N′,N′-tetramethylthiourea and N,N,N′,N′-tetraethylthiourea.

In an alternatively preferred embodiment R⁵ and R⁶ and also R⁷ and R⁸ each together are C₂-C₅-alkylene, with one methylene group (CH₂) in the alkylene chain possibly being replaced by a carbonyl group (CO); that is, R⁵ and R⁶ together form a C₂-C₅-alkylene group in which a methylene group (CH₂) in the alkylene chain may be replaced by a carbonyl group (CO), and R⁷ and R⁸ together form a C₂-C₅-alkylene group in which a methylene group (CH₂) in the alkylene chain may be replaced by a carbonyl group (CO). Examples thereof are di(tetrahydro-1H-pyrrol-1-yl)methanethione, bis(pentamethylene)thiourea and thiocarbonylbiscaprolactam.

In an alternatively preferred embodiment R⁶ and R⁸ are hydrogen and R⁵ and R⁷ together form a C₂-C₅-alkylene group, with a methylene group possibly being replaced by a thiocarbonyl group. Examples thereof are ethylenethiourea and also 1,2- or 1,3-propylenethiourea.

In an alternatively preferred embodiment R⁵ and R⁶ and also R⁷ and R⁸ each together with the nitrogen atom to which they are attached form an unsaturated aromatic or nonaromatic heterocycle as defined above. Examples thereof are thiocarbonyldipyrazole and thiocarbonyldiimidazole.

Guanidine can also be used in the form of a guanidine salt, such as guanidine nitrate or, more particularly, guanidine carbonate.

In one preferred embodiment, in the substituted guanidines, R¹⁰, R¹¹, and R¹³ are hydrogen and R⁹ and R¹² are alike or different and are C₁-C₁₂-alkyl, aryl or aryl-C₁-C₄-alkyl. Examples thereof are N,N′-dimethylguanidine, N,N′-diethylguanidine, N,N′-dipropylguanidine, N,N′-diisopropylguanidine, N,N′-di-n-butylguanidine, N,N′-diisobutylguanidine, N,N′-di-sec-butylguanidine, N,N′-di-tert-butylguanidine, N,N′-dipentylguanidine, N,N′-dihexylguanidine, N,N′-diheptylguanidine, N,N′-dioctylguanidine, N,N′-didecylguanidine, N,N′-didodecylguanidine, N,N′-diphenylguanidine, N,N′-dinaphthylguanidine, N,N′-ditolylguanidine, N,N′-dibenzylguanidine, N-methyl-N′-phenylguanidine, and N-ethyl-N′-phenylguanidine.

In an alternatively preferred embodiment R⁹, R¹⁰, R¹², and R¹³ are alike and are linear C₁-C₄-alkyl and R¹¹ is H or methyl and more particularly H. Examples thereof are N,N,N′,N′-tetramethylguanidine and N,N,N′,N′-tetraethylguanidine.

In an alternatively preferred embodiment R⁹ and R¹⁰ and also R¹² and R¹³ each together are C₂-C₅-alkylene, with one methylene group (CH₂) possibly being replaced by a carbonyl group (CO); that is, R⁹ and R¹⁰ together form a C₂-C₅-alkylene group in which a methylene group (CH₂) may be replaced by a carbonyl group (CO), and R¹² and R¹³ together form a C₂-C₅-alkylene group in which a methylene group (CH₂) may be replaced by a carbonyl group (CO), and R¹¹ is H or methyl and more particularly H.

Examples thereof are di(tetrahydro-1H-pyrrol-1-yl)imine, bis(pentamethylene)guanidine and iminobiscaprolactam.

In an alternatively preferred embodiment R¹⁰, R¹¹, and R¹³ are hydrogen and R⁹ and R¹² together form a C₂-C₅-alkylene group, with a methylene group optionally being replaced by a carbonyl group. Examples thereof are ethyleneguanidine and also 1,2- or 1,3-propyleneguanidine.

In an alternatively preferred embodiment R⁹ and R¹⁰ and also R¹² and R¹³ each together with the nitrogen atom to which they are attached form an unsaturated aromatic or nonaromatic heterocycle as defined above, and R¹¹ is H or methyl and more particularly H. Examples thereof are iminodipyrazole and iminodiimidazole.

In one preferred embodiment R¹⁴ and R¹⁵ are C₁-C₄-alkyl. With particular preference the two radicals are alike. Examples thereof are dimethyl carbonate, diethyl carbonate, dipropyl carbonate, diisopropyl carbonate, di-n-butyl carbonate, di-sec-butyl carbonate, diisobutyl carbonate, and di-tert-butyl carbonate. Of these, preference is given to dimethyl carbonate and diethyl carbonate.

In one alternatively preferred embodiment R¹⁴ and R¹⁵ together are C₂-C₅-alkylene and preferably C₂-C₃-alkylene. Examples of such carbonates are ethylene carbonate and also 1,2- and 1,3-propylene carbonate.

Preference among the urea derivatives stated above is given to the substituted ureas, thiourea, the substituted thioureas, guanidine (including the guanidine salts), the substituted guanidines, and the carbonic esters. More strongly preferred are the substituted ureas, thiourea, guanidine (including the guanidinium salts), and the carbonic esters. Preference among these is given to thiourea, N,N′-dimethylurea, N,N′-diethylurea, N,N′-di-n-butylurea, N,N′-diisobutylurea, N,N,N,N′-tetramethylurea, guanidine, in the form particularly of guanidine carbonate, dimethyl carbonate, diethyl carbonate, ethylene carbonate, and 1,2-propylene carbonate. Even more strongly preferred are the substituted ureas and guanidine, in the form particularly of guanidine carbonate. Preference among these is given to substituted ureas, N,N′-dimethylurea, N,N′-diethylurpa, N,N′-di-n-butylurea, N,N′-diisobutylurea, and N,N,N′,N′-tetramethylurea.

Particular preference is given to using as component (ii-1), (iii-2), (v-1), and (vi-2) urea or substituted urea of the formula R¹R²N—C(═O)—NR³R⁴ in which R¹, R², R³, and R⁴ independently of one another are as defined above. Preferably R¹ and R³ are H or C₁-C₄-alkyl, especially methyl or ethyl, and R² and R⁴ are C₁-C₄-alkyl, especially methyl or ethyl. More particularly use is made as component (ii-1), (iii-2), (v-1), and (vi-2) of urea itself, optionally in combination with one of the aforementioned urea derivatives, and especially just urea.

The at least one further amine (i-3), (iii-4), (iv-3), and (vi-4) used optionally in the preparation of polymers and oligomers (i), (iii), (iv), and (vi) preferably comprises amines having one primary amino group, amines having at least three primary amino groups, or mixtures thereof.

The use of amines with only one primary amino function is appropriate in particular when the degree of branching of the polymers (i) and (iii) is to be relatively low.

The amines having one primary amino group comprise an amine having a single primary amino function and optionally one or more secondary and/or tertiary amino groups.

Examples of primary amines without further secondary/tertiary amino functions (primary monoamines) are compounds of the formula R—NH₂, in which R is an aliphatic, alicyclic, aliphatic-alicyclic, aromatic or araliphatic radical, of course comprising no amino groups.

Examples of these are methylamine, ethylamine, propylamine, isopropylamine, n-butylamine, sec-butylamine, isobutylamine, tert-butylamine, pentylamine, hexylamine, ethanolamine, propanolamine, isopropanolamine, pentanolamine, (2-methoxyethyl)amine, (2-ethoxyethyl)amine, (3-methoxypropyl)amine, (3-ethoxypropyl)amine, [3-(2-ethylhexyl)propyl]amine, 2-(2-aminoethoxy)ethanol, cyclohexylamine, aminomethylcyclohexane, aniline, benzylamine, and the like.

Examples of amines having a single primary amino function and one or more secondary and/or tertiary amino functions (polyamines having one (single) primary amino group) are N-methylethylene-1,2-diamine, N,N-dimethylethylene-1,2-diamine, N-ethylethylene-1,2-diamine, N,N-diethylethylene-1,2-diamine, N-methylpropylene-1,3-diamine, N,N-dimethylpropylene-1,3-diamine, N-ethylpropylene-1,3-diamine, N,N-diethylpropylene-1,3-diamine, N-methylbutylene-1,4-diamine, N,N-dimethylbutylene-1,4-diamine, N-methylpentylene-1,5-diamine, N,N-dimethylpentylene-1,5-diamine, N-methylhexylene-1,6-diamine, N,N-dimethylhexylene-1,6-diamine, N-methyldiethylenetriamine, N,N-dimethyldiethylenetriamine, N-methyltriethylene-tetramine, N,N-dimethyltriethylenetetramine, N-methyltetraethylenepentamine, N,N-dimethyltetraethylenepentamine, (3-(methylamino)propyl)(3-aminopropyl)amine, (3-(dimethylamino)propyl)(3-aminopropyl)amine, (2-aminoethyl)ethanolamine, N-(2-hydroxyethyl)-1,3-propanediamine, N-methyldiaminocyclohexane, N,N-dimethyldiaminocyclohexane, N-methylphenylenediamine, and the like.

The use of amines having at least three primary amino functions is appropriate in particular when the degree of branching of the polymers (i) and (iii) is to be increased.

Examples of such compounds are the abovementioned amines of the formulae II and III, but where R^{d}, R^{e}, R^{f} and at least three of the radicals Rⁱ, R^{j}, R^{k}, and R^{l} are H, with the exception of melamine and melamine derivatives.

Examples of amines having at least three primary and/or secondary amino groups, of the formulae II and III, are N,N-bis(3-aminopropyl)propane-1,3-diamine, N,N-bis(3-aminopropyl)butane-1,4-diamine, N,N,N′N′-tetra(3-aminopropyl)ethylenediamine, N,N,N′N′-tetra(3-aminopropyl)-1,4-butylenediamine, tris(2-aminoethyl)amine, tris(2-aminopropyl)amine, tris(3-aminopropyl)amine, tris(2-aminobutyl)amine, tris(3-aminobutyl)amine, tris(4-aminobutyl)amine, tris(5-aminopentyl)amine, tris(6-aminohexyl)amine, trisaminohexane, trisaminononane, 4-aminomethyl-1,8-octamethylenediamine, and the like.

The at least one further amine (ii-3) and (v-3) used optionally in the preparation of polymers and oligomers (ii) and (v) are preferably amines having a primary amino group. Suitable amines having a primary amino group correspond to those specified above for components (i-3), (iii-4), (iv-3), and (vi-4).

For the preparation of highly branched polymers (i), component (i-1) and component (ii-2) are used in a total weight ratio of preferably 1:1 to 1:20, more preferably 1:1.5 to 1:10, and more particularly 1:2 to 1:5, e.g., 1:2 to 1:4 or 1:2 to 1:3.5.

If an amine (i-3) as well is used in the condensation reaction, the weight ratio of component (i-2) to component (i-3) is preferably 2:1 to 100:1, more preferably 5:1 to 100:1, and more particularly 10:1 to 50:1.

For the preparation of highly branched polymers (ii), component (ii-1) and component (ii-2) are in a total weight ratio of preferably 20:1 to 1:20, more preferably 10:1 to 1:10, and more particularly 5:1 to 1:5.

If component (ii-2), in addition to the at least one amine having at least three primary and/or secondary amino groups, also comprises at least one amine having two primary and/or secondary amino groups, then the total weight ratio of the at least one amine having at least three primary and/or secondary amino groups to the at least one amine having two primary and/or secondary amino groups used is preferably 1:1 to 1:20, more preferably 1:1.5 to 1:10, and more particularly 1:2 to 1:5.

If an amine (ii-3) as well is used in the condensation reaction, the weight ratio of component (ii-2) to component (ii-3) is preferably 2:1 to 100:1, more preferably 5:1 to 100:1, and more particularly 10:1 to 50:1.

For the preparation of highly branched polymers (iii), component (iii-2) and the entirety of component (iii-1) and (iii-3) are used in a weight ratio of preferably 20:1 to 1:20, more preferably 10:1 to 1:10, and more particularly 5:1 to 1:5. The total weight ratio of component (iii-1) and component (iii-3) is preferably 1:1 to 1:20, more preferably 1:1.5 to 1:10, and more particularly 1:2 to 1:5.

If an amine (iii-4) as well is used in the condensation reaction, the weight ratio of component (iii-3) to component (iii-4) is preferably 2:1 to 100:1, more preferably 5:1 to 100:1, and more particularly 10:1 to 50:1.

For the preparation of the oligomers (iv), the components are used preferably in the weight proportions indicated for the polymer (i).

For the preparation of the oligomers (v), the components are used preferably in the weight proportions indicated for the polymer (ii).

For the preparation of the oligomers (vi), the components are used preferably in the weight proportions indicated for the polymer (iii).

Highly branched polymers (i), (ii), and (iii) and processes for preparing them are known in principle and are described for example in WO 2005/044897 and WO 2005/075541, hereby incorporated in full by reference.

The preparation is accomplished in general by reaction of the respectively indicated components at elevated temperature.

The reaction temperature is preferably 40 to 300° C., more preferably 100 to 250° C., and more particularly 150 to 230° C.

The reaction takes place frequently in the presence of a suitable catalyst. Suitable catalysts are bases, such as alkali metal and alkaline earth metal hydroxides, examples being sodium hydroxide, potassium hydroxide, calcium hydroxide or magnesium hydroxide, alkali metal and alkaline earth metal hydrogen carbonates, examples being sodium hydrogen carbonate, potassium hydrogen carbonate, calcium hydrogen carbonate or magnesium hydrogen carbonate, alkali metal and alkaline earth metal carbonates, examples being sodium carbonate, potassium carbonate, calcium carbonate or magnesium carbonate, basic, nonnucleophilic amines, such as DBU (diazabicycloundecene), DBN (diazabicyclononene), DABCO (diazabicyclooctane), nitrogen-containing heterocycles, such as imidazole, 1- and 2-methylimidazole, 1,2-dimethylimidazole, pyridine, lutidine, and the like. Suitable catalysts are additionally organic aluminum, tin, zinc, titanium, zirconium, and bismuth compounds, such as titanium tetrabutoxide, dibutyltin oxide, dibutyltin dilaurate, tin dioctoate, zirconium acetylacetonate, and mixtures thereof.

More particularly if the amine component comprises melamine, however, it is preferred to use Brönsted acids or Lewis acids as catalysts. Suitable Brönsted acids are not only inorganic acids, such as, for example, mineral acids, examples being hydrofluoric acid, hydrochloric acid, hydrobromic acid, nitric acid, sulfuric acid, phosphoric acid, phosphorous acid, or amidosulfonic acid, and also ammonium salts, such as ammonium fluoride, ammonium chloride, ammonium bromide or ammonium sulfate, but also organic acids, such as methanesulfonic acid, acetic acid, trifluoroacetic acid, and p-toluenesulfonic acid. Suitable Brönsted acids are also the ammonium salts of organic amines, such as ethylamine, diethylamine, propylamine, dipropylamine, butylamine, dibutylamine, aniline, benzylamine or melamine, and also the ammonium salts of urea.

Suitable Lewis acids are all metal or semimetal halides in which the metal or semimetal possesses an electron pair vacancy. Examples thereof are BF₃, BCl₃, BBr₃, AIF₃, AlCl₃, AlBr₃, ethylaluminum dichloride, diethylaluminum chloride, TiF4, TiCl₄, TiBr₄, VCl₅, FeF₃, FeCl₃, FeBr₃, ZnF2, ZnCl₂, ZnBr₂, Cu(I)F, Cu(I)Cl, Cu(I)Br, Cu(II)F₂, Cu(II)Cl₂, Cu(II)Br₂, Sb(III)F₃, Sb(V)F₅, Sb(III)Cl₃, Sb(V)Cl₅, Nb(V)Cl₅, Sn(II)F₂, Sn(II)Cl₂, Sn(II)Br₂, Sn(IV)F₄, Sn(IV)Cl₄, and Sn(IV)Br₄.

Preferably, however, Brönsted acids are used.

With particular preference, the condensation takes place in the absence of a catalyst or with use of a halogen-free mineral acid (inorganic Brönsted acid) as catalyst. Suitable halogen-free mineral acids are nitric acid, sulfuric acid, phosphoric acid, phosphorous acid, and amidosulfonic acid, and also mixtures thereof. Use is made more particularly of phosphoric acid, phosphorous acid, and especially mixtures thereof. If a mixture of phosphoric acid and phosphorous acid is used, the weight ratio thereof is preferably 20:1 to 1:20, more preferably 10:1 to 1:10, even more preferably 5:1 to 1:5, and more particularly 3:1 to 1:3.

Overall, the condensation takes place preferably in the absence of halogen-containing compounds.

The reaction can be carried out either at atmospheric pressure or at a superatmospheric pressure, such as, for example, at a pressure of 1 to 20 bar or 1 to 15 bar or 10 to 15 bar. In the preparation of polymers (ii) and (iii), the pressure is frequently built up solely by the ammonia that is released in the course of the reaction, during the condensation of the components (in the case of urea, thiourea, guanidine and/or biuret as component (ii-1) and (iii-2)); that is, the pressure increases as the reaction progresses, and can then be adjusted to the desired level. For preparing polymer (i), or generally if the reaction is to be carried out at a superatmospheric pressure, however, the pressure can also be built up by way of an inert gas, such as by introduction of nitrogen, argon or carbon dioxide, preferably nitrogen, for example. In the case of polymers (ii) and (iii) this is appropriate more particularly when the reaction is to be carried out under a superatmospheric pressure right from the beginning, in other words before any notable pressure can be produced at all by the ammonia that is formed. The reaction pressure is determined more particularly by the nature of the amines used. Hence the reaction can be carried out at atmospheric pressure if the at least one amine used has a boiling point which is above the reaction temperature. If, on the other hand, the boiling point is below the reaction temperature, then it is of course advantageous to carry out the reaction at superatmospheric pressure. However, even in the case of amines having a boiling point above the reaction temperature, it may under certain circumstances be advantageous to carry out the reaction under superatmospheric pressure, in order for example to achieve a higher reaction rate.

The reaction can be carried out if desired in a suitable solvent. Suitable solvents are inert: that is, under the prevailing reaction conditions, they do not react with the reactants, intermediates or products, and are not themselves degraded, by thermal decomposition, for example, under the prevailing reaction conditions either. Examples of suitable solvents are chlorinated aliphatic or aromatic hydrocarbons, such as methylene chloride, chloroform, dichloroethane, trichloroethane, chlorobenzene, chlorotoluene, and o-dichlorobenzene, open-chain and cyclic ethers, such as diethyl ether, dipropyl ether, tert-butyl methyl ether, tert-butyl ethyl ether, tetrahydrofuran, and 1,4-dioxane, polar aprotic solvents, such as N,N-dimethylformamide, N,N-dimethylacetamide, dimethyl sulfoxide, and acetonitrile, and polar protic solvents, examples being polyols, including polyether polyols, such as ethylene glycol, propylene glycol, diethylene glycol, triethylene glycol or polyethylene glycol. Preferred solvents are the abovementioned polyols, including polyether polyols. Ethylene glycol is used especially. Possibly, though, the reaction is carried out in bulk, in other words without additional solvent. In this case frequently an amine serves as solvent, more particularly when it is liquid and is used in excess. The procedure, however, is preferably accomplished in a solvent, more particularly in one of the preferred solvents identified above.

The reaction can be carried out by mixing all of the components and bringing the mixture to reaction by heating it to the desired reaction temperature. Alternatively it is possible for part of the components to be added first and the remaining constituents to be supplied gradually, the sequence of the addition being of minor importance. However, it has proven appropriate not to include all of the less soluble components in the initial charge, such as melamine or urea, but instead to supply them gradually, continuously or in portions. The addition of the individual reactants advantageously takes place in such a way as to ensure their complete dissolution, so that their conversion in the condensation reaction is as complete as possible.

The reaction is generally carried out in reaction vessels that are typical for such condensation reactions, as for example in heatable stirred reactors, stirred pressure vessels or stirred autoclaves.

The reaction mixture is generally left to react until a desired maximum viscosity has been reached. The viscosity can be determined by sampling and determination by means of typical methods, such as with a viscometer, for example; in many cases, however, a sharp increase in viscosity is already evident visually in the course of the reaction, through the foaming of the reaction mixture, for example.

The reaction is preferably discontinued when the reaction mixture has attained a certain desired viscosity, e.g., a viscosity of not more than 150 000 mPas, e.g., from 250 to 150 000 mPas or from 500 to 150 000 mPas or from preferably 750 to 150 000 mPas (at 100° C.), preferably a viscosity of not more than 100 000 mPas, e.g., from 250 to 100 600 mPas or from 500 to 100 000 mPas or from preferably 750 to 100 000 mPas (at 100° C.), more preferably of not more than 50 000 mPas, e.g., from 250 to 50 000 mPas or from 500 to 50 000 mPas or from preferably 750 to 50 000 mPas (at 100° C.), and more particularly of not more than 10 000 mPas, e.g., from 250 to 10 000 mPas or from 500 to 10 000 mPas or from preferably 750 to 10 000 mPas (at 100° C.).

If the viscosity of the reaction mixture is not to rise further, the reaction is discontinued. The reaction is preferably discontinued by lowering the temperature, preferably by lowering the temperature to <100°, e.g., 20 to <100°, preferably to <50° C., e.g., to 20 to <50° C.

In certain circumstances it may be necessary or desirable to work up and purify the reaction mixture obtained. Workup/purification may take place by means of typical methods, as for example by deactivating or removing the catalyst and/or by removing solvent and unreacted reactants. In general, however, the purity of the polycondensates obtained is sufficient, so there is no need for any further workup or purification and the product can be supplied directly to its further target use as a curative.

The polymers (i), (ii), and (iii) are highly branched and substantially noncrosslinked.

The oligomers (iv), (v), and (vi) can be prepared in accordance with customary condensation processes, as for example in accordance with the processes described for the polymers (i), (ii), and (iii). An onward reaction to polymeric products can be prevented, for example, by using the amine (iv-2), (v-2) and/or (vi-3) in a large excess (for example, melamine (derivative) (iv-1): amine (iv-2)=at least 1:10 or preferably at least 1:30 or more preferably at least 1:100), and/or by monitoring and limiting the conversion of the condensation reaction, by conducting the reaction at moderate temperatures and/or suddenly lowering the temperature, after reaction at relatively high reaction temperatures, and hence significantly slowing the reaction rate, and/or destroying or neutralizing any catalysts added, after the desired degree of conversion has been reached, and/or conducting the condensation reaction under conditions of high dilution in a suitable solvent.

Alternatively, the oligomers (iv), (v), and (vi) are also produced as by products in the preparation of the polymers (i), (ii), and (iii), respectively, and can be isolated from the reaction mixture from that preparation, by means, for example, of extraction with a solvent in which the polymer (i), (ii), or (iii) is not soluble.

The oligomers used in accordance with the invention are also prepared preferably in the absence of a catalyst or else using a halogen-free mineral acid (inorganic Brönsted acid) catalyst. For suitable and preferred halogen-free mineral acids, refer to the observations above.

The oligomers used in accordance with the invention are also prepared preferably entirely in the absence of halogen-containing compounds.

Among the condensation products used in accordance with the invention, the highly branched polymers (i) are preferred.

These highly branched polymers (i) are preferably obtainable by the condensation of
(i-1a) melamine, optionally in a mixture with at least one melamine derivative;
(i-2a) at least one amine of the formula I as defined above, in which A is linear or branched C₂-C₂₀-alkylene;
(i-2b) at least one amine of the formula I as defined above, in which A is a divalent radical of the formula

B—Xₘ—B—
in which B, X, and m possess one of the general definitions indicated above or, more particularly, one of the preferred definitions indicated above; and
(i-3) optionally at least one amine having a primary amino group and/or at least one amine having at least three primary amino groups, which is different from melamine and from the at least one melamine derivative;
   more preferably of
(i-1a) melamine, optionally in a mixture with at least one melamine derivative;
(i-2a) at least one amine of the formula I as defined above, in which A is linear or branched C₂-C₁₀-alkylene, preferably linear or branched C₄-C₈-alkylene, and more particularly linear C₄-C₈-alkylene;
(i-2b) at least one amine of the formula I as defined above, in which A is a divalent radical of the formula

B—Xₘ—B—
in which X independently is NR^{c}, in which R^{c}C is as defined above and preferably is H or C₁-C₄-alkyl, more preferably H or methyl, and more particularly H;
each B independently is C₂-C₃-alkylene and preferably 1,2-ethylene or 1,3-propylene; and
m is a number from 1 to 20, preferably from 1 to 10, more preferably from 1 to 6,
and more particularly 1 to 4; and
(i-3) optionally at least one amine having a primary amino group and/or at least one amine having at least three primary amino groups, which is different from melamine and from the at least one melamine derivative; and
   more particularly of
(i-1a) melamine, optionally in a mixture with at least one melamine derivative;
(i-2a) at least one amine of the formula I as defined above, in which A is linear C₄-C₈-alkylene;
(i-2b) at least one amine of the formula I as defined above, in which A is a divalent radical of the formula

B—Xₘ—B—
in which X independently is NH;
each B independently is 1,2-ethylene or 1,3-propylene; and
m is a number from 1 to 1, preferably from 1 to 6, and more particularly from 1 to 4; and
(i-3) optionally at least one amine having a primary amino group and/or at least one amine having at least three primary amino groups, which is different from melamine and from the at least one melamine derivative; and
   especially of
(i-1a) melamine, optionally in a mixture of at least one melamine derivative;
(i-2a) at least one amine selected from 1,2-ethylenediamine, 1,3-propylenediamine, 1,4-butylenediamine, 1,5-pentylenediamine, hexamethylenediamine, heptamethylenediamine, octamethylenediamine, and mixtures thereof;
(i-2b) at least one amine selected from diethylenetriamine, triethylenetetramine, tetraethylenepentamine, pentaethylenehexamine, hexaethyleneheptamine, heptaethyleneoctamine, octaethylenenonamine, higher polyimines, bis(3-amino-propyl)amine, bis(3-aminopropyl)methylamine, N4-amine (N,N′-bis(3-amino-propyl)ethylenediamine), and mixtures thereof; and
(i-3) optionally at least one amine having a primary amino group and/or at least one amine having at least three primary amino groups, which is different from melamine and from the at least one melamine derivative; and
   even more especially of
(i-1a) melamine, optionally in a mixture of at least one melamine derivative;
(i-2a) at least one amine selected from 1,4-butylenediamine, 1,5-pentylenediamine, hexamethylenediamine, heptamethylenediamine, octamethylenediamine, and mixtures thereof;
(i-2b) at least one amine selected from diethylenetriamine, triethylenetetramine, tetraethylenepentamine, pentaethylenehexamine, N4-amine (N,N′-bis(3-amino-propyl)ethylenediamine), and mixtures thereof; and
(i-3) optionally at least one amine having a primary amino group and/or at least one amine having at least three primary amino groups, which is different from melamine and from the at least one melamine derivative.

If melamine is used in a mixture of at least one melamine derivative, then the weight ratio of melamine to the total amount of the at least one melamine derivative is preferably 1:2 to 1000:1, more preferably 1:1 to 500:1, and more particularly 2:1 to 100:1.

The weight ratio of component (i-2a) to (i-2b) is preferably 10:1 to 1:10, more preferably 5:1 to 1:5, even more preferably 2:1 to 1:2, and more particularly 1.5:1 to 1:1.5.

The optionally used at least one amine having at least three primary amino groups, of component (i-3), is preferably selected from amines of the formula II and III as defined above.

In accordance with the invention, the polymers and/or oligomers (i) to (vi) are used for reducing, preventing or retarding the corrosion of corrosion-threatened materials.

The corrosion-threatened materials are preferably corrosion-threatened metals. These metals are preferably selected from iron, zinc, aluminum, copper, tin, lead, manganese, nickel, and alloys thereof, and more preferably from iron, zinc, aluminum, and alloys thereof. The alloys of iron are preferably steel or cast iron. The steels are preferably black steel (unalloyed steel which has not been electroplated), carbon steel (0.2-1.7% carbon fraction), Invar steel (35.5% nickel fraction), manganese steel (“ferromanganese”; 75-98% iron+0.8-25% manganese+0.5% silicon+0.1-1.5% carbon), silicon steel (“ferrosilicon”; 85-98% iron+0.5-15% silicon+0.1-1.7% carbon), or tungsten steel (“ferrotungsten”; 70-98% iron+2-18% tungsten+2.5% chromium+0.6-0.8% carbon). Also suitable are metal composites, examples being galvanized metal sheets or galvanized steel.

With particular preference the metals are selected from iron and alloys of iron, and more particularly from iron and steels, especially iron and the steels identified above.

The materials to be protected may be present in any form, as for example in the form of precursor products, examples being foils, sheets or coils (rolled metal strips), or in the form of semifinished and completed products, for example pipes, components, constructions, tools, automobile parts, bodywork parts, instrument panels, facçade panels, ceiling panels, window profiles, and many others.

The reducing, preventing or retarding of the corrosion is preferably achieved by using the polymers and/or oligomers, used in accordance with the invention, as anticorrosion compositions or as corrosion inhibitors.

In the context of the present invention, the term “anticorrosion compositions” is applied to compounds which are applied, in or as coating compositions, to the materials to be protected from corrosion—in other words, the compounds, together optionally with further substances, form a protective film on the materials to be protected.

The term “corrosion inhibitor”, in contrast, refers to compounds which are added to the corrosive medium in order to react there with the corrosion-causing or corrosion-promoting substances and to reduce their aggressiveness or even to suppress it entirely.

The polymers (i) to (iii) are used preferably as anticorrosion compositions. The oligomers (iv) to (vi) may be used both as anticorrosion compositions and as corrosion inhibitors.

The polymers and oligomers used in accordance with the invention can be employed as corrosion inhibitors in acidic, neutral or basic media.

On account of the good binding properties of the polymers and oligomers used in accordance with the invention to the materials to be protected, it is not possible, where they are used as corrosion inhibitors, to make a strict distinction between the pure inhibitor effect and the anticorrosion effect, since the polymers and oligomers attach very effectively to the substrate surfaces and therefore not only react with the corrosive medium but also form a protective coat as well.

If the polymers and oligomers used in accordance with the invention are employed as anticorrosion compositions, they may be used in all forms customary for anticorrosion compositions, as for example in the form of coating materials (e.g., paints) or else in dipping baths (e.g., for simple dipping, but also for cathodic electrodeposition (cathodic electrocoat)).

In the context of use as anticorrosion compositions, the materials to be treated are contacted generally with a preparation which comprises at least one of the polymers or oligomers used in accordance with the invention. The contacting is accomplished, for example, by spraying or otherwise applying a preparation, such as a coating material or spraying composition, for example, comprising at least one of the polymers or oligomers used in accordance with the invention, to the material that has to be protected—not least, for example, by the coil coating process. These processes are suitable not only for light corrosion control but also for medium or heavy-duty corrosion control. Furthermore, the polymers employed in accordance with the invention can be used in dipping baths, such as in simple dipping baths or else in cathodic electrodeposition, for example. After contacting has been accomplished, the applied film is generally cured, and this may take place, for example, under atmospheric conditions, but also with additional heating or irradiation.

Besides the polymers or oligomers used in accordance with the invention, coating materials for use in accordance with the invention generally comprise at least one binder and optionally further components, such as solvents, crosslinkers, fillers, pigments, reactive diluents, rheological assistants, UV absorbers, light stabilizers, free-radical scavengers, radical polymerization initiators, thermal crosslinking catalysts, slip additives, polymerization inhibitors, defoamers, emulsifiers, degassing agents, wetting agents, dispersants, adhesion promoters, flow control agents, film-forming assistants, rheology control additives (thickeners), flame retardants, siccatives, antiskinning agents or other anticorrosion agents/corrosion inhibitors.

Since the polymers and oligomers used in accordance with the invention have good binder properties, they are able to replace some or all of the otherwise customary binders in the coating materials referred to above.

Customary binders include, for example, (meth)acrylic acid (co)polymers, examples being styrene/acrylic acid copolymers, (meth)acrylate (co)polymers, partially hydrolyzed polyvinyl esters, polyesters, alkyd resins, polylactones, polycarbonates, polyethers, epoxy resin-amine adducts, polyureas, polyamides, polyimides or polyurethanes or mixtures thereof. Customary binders may be aqueously soluble or organically soluble binder systems. They are preferably binder systems on an aqueous basis. Binders suitable for aqueous systems are, for example, epoxy resins, polyacrylates, styrene-acrylic acid polymers, styrene-acrylate polymers, polyesters, alkyd resins, polyurethanes or styrene-butadiene polymers.

The purpose of the solvents optionally present is to dissolve and/or disperse the other components of the coating material, in order to allow uniform application to the material to be treated. It is, however, also possible in principle to formulate the preparation in solvent-free or substantially solvent-free form, as a powder coating material. The use of a solvent is preferred. Suitable solvents are those capable of dissolving, dispersing, suspending or emulsifying the polymers or oligomers used in accordance with the invention. They may be organic solvents, water or aqueous ammoniacal solutions. It will be appreciated that mixtures of different organic solvents or mixtures of organic solvents with water may also be used.

Examples of organic solvents include hydrocarbons such as toluene, the xylenes, the Solvesso® products, more particularly Solvesso® 100, 150, and 200, and also the Shellsol® products from Shell, or mixtures as obtained in the refining of crude oil, such as hydrocarbon fractions of defined boiling ranges, for example, ethers such as THF or polyethers such as polyethylene glycol, ether alcohols such as ethylene glycol mono-n-butyl ether (butylglycol), propylene glycol monoethyl ether, dipropylene glycol monomethyl ether or propylene glycol monomethyl ether, ether glycol acetates such as butyl-glycol acetate or propylene glycol monomethyl ether acetate, ketones such as acetone, alcohols such as methanol, ethanol or propanol, or lactams, such as N-methylpyrrolidone, N-ethylpyrrolidone, N-(n-butyl)pyrrolidone or N-cyclohexylpyrrolidone.

It is possible, furthermore, for water or a predominantly aqueous solvent mixture to be used. By this are meant those mixtures which comprise at least 50%, preferably at least 65%, and more preferably at least 80% of water, by weight. Further components are water-miscible solvents. Examples include monoalcohols such as methanol, ethanol or propanol, higher alcohols such as ethylene glycol or polyether polyols and ether alcohols such as butylglycol or methoxypropanol.

The crosslinkers may be thermally curing or photochemically curing crosslinkers.

Examples of suitable thermal crosslinkers include crosslinkers based on epoxides, in which two or more epoxide groups are joined to one another by means of a linking group. Examples include low molecular mass compounds having two epoxide groups, such as hexanediol diglycidyl ether, phthalic acid diglycidyl ether or cycloaliphatic compounds such as 3,4-epoxycyclohexylmethyl 3′,4′-epoxycyclohexanecarboxylate. Further examples of suitable crosslinkers include crosslinkers based on amino resins, examples being melamine-formaldehyde resins, urea-formaldehyde resins or tris(alkoxycarbonyl)triazines. Furthermore, blocked polyisocyanates are suitable crosslinkers. For blocking, the isocyanate group is reacted reversibly with a blocking agent. The blocking agent will be eliminated again on heating to higher temperatures. Examples of suitable blocking agents are described in DE-A 199 14 896 and in D. A. Wicks, Z. W. Wicks, Progress in Organic Coatings, 36, 148-172 (1999), 41, 1-83 (2001) and also 43, 131-140 (2001), and are, for example, phenols, imidazoles, triazoles, pyrazoles, oximes, N-hydroxyimides, hydroxybenzoic esters, secondary amines, lactams, CH-acidic cyclic ketones, malonic esters or alkyl acetoacetates.

The fillers are generally inorganic, finely divided fillers. However, they may also comprise an additional organic coating, for the purpose of hydrophobizing or hydrophilizing, for example. The filler ought not to exceed an average particle size of 10 μm. The average particle size is preferably 10 nm to 8 μm, this FIGURE being based on the longest axis of the particles. By the particle size is meant the primary particle size, since the skilled person is of course aware that finely divided solids frequently undergo agglomeration to form larger particles, which for use must be intensively dispersed.

With fillers it is possible to influence the properties of the coating, such as, for example, hardness, rheology, or the orientation of any effect pigments there may be in the coating material. Fillers are frequently inactive coloristically; that is, they exhibit low inherent absorption, and the refractive index is similar to the refractive index of the coating medium. Examples of fillers include talc, calcium carbonate, kaolin, barium sulfate, magnesium silicate, aluminum silicate, crystalline or nanoparticulate silicon dioxide, amorphous silica, aluminum oxide, microbeads or hollow microbeads made, for example, of glass, ceramic or polymers, with sizes of 0.1 to 10 μm, for example. As fillers it is additionally possible to use any desired solid inert organic particles, such as, for example, urea-formaldehyde condensation products, micronized polyolefin wax or micronized amide wax. The inert fillers can each also be used in a mixture. It is preferred, however, to use only one filler in each case.

The pigments may more particularly be anticorrosion pigments. These may be active or passive anticorrosion pigments.

Examples of active anticorrosion pigments include, in particular, phosphates, phosphate-containing or modified phosphates such as pigments based on zinc phosphate, zinc aluminum orthophosphate, zinc molybdenum orthophosphate, zinc aluminum molybdenum orthophosphate, calcium hydrogen phosphate, zinc calcium strontium ortho-phosphate silicate, zinc aluminum polyphosphate, strontium aluminum polyphosphate, zinc calcium aluminum strontium orthophosphate polyphosphate silicate, calcium aluminum polyphosphate silicate. Further examples include combinations or inorganic phosphates with electrochemically active, organic corrosion inhibitors of low solubility, such as zinc phosphate modified with Zn salts or Ca salts of 5-nitroisophthalic acid. In addition, it is also possible to use iron phosphide, zinc hydroxyphosphide, borosilicate pigments such as barium metaborate or zinc borophosphates, molybdates such as zinc molybdate, sodium zinc molybdates or calcium molybdate, pigments with ion exchange properties such as amorphous SiO₂ modified with calcium ions, or silicates modified correspondingly, metal oxides such as, for example, ZnO or else metal powders such as, for example, zinc dust. It will be appreciated that typical organic anticorrosion pigments can also be used, such as Zn salts or Ca salts of 5-nitroisophthalic acid, for example.

Passive anticorrosion pigments lengthen the diffusion pathways for corrosive components and thereby increase the corrosion resistance. Examples include, in particular, platelet-shaped or lamelliform pigments such as mica, hematite, phyllosilicates, linear polysilicates such as, for example, wollastonite, talc or metal platelets such as aluminum platelets or iron platelets. Further details of anticorrosion pigments are described in, for example, “Pigments, 4.2 Anticorrosive Pigments” in Ullmann's Encyclopedia of Technical Chemistry, 6th Edition 2000, Electronic Release.

The pigments may also be typical coloring and/or effect pigments.

By effect pigments are meant all pigments which exhibit a platelet-shaped structure and impart specific decorative color effects to a surface coating. Effect pigments are known to the skilled person. Examples include pure metal pigments, such as aluminum, iron or copper pigments, for example, interference pigments, such as titanium dioxide-coated mica, iron oxide-coated mica, mixed oxide-coated mica (e.g., with titanium dioxide and Fe₂O₃), for example, metal oxide-coated aluminum, or liquid-crystal pigments.

Color pigments are, in particular, customary organic or inorganic absorption pigments that can be used in the paint industry. Examples of organic absorption pigments are azo pigments, phthalocyanine, quinacridone, and pyrrolopyrrole pigments. Examples of inorganic absorption pigments are iron oxide pigments, titanium dioxide, and carbon black.

Examples of dyes are azo, azine, anthraquinone, acridine, cyanine, oxazine, polymethine, thiazine, and triarylmethane dyes. These dyes may find application as basic or cationic dyes, mordant dyes, direct dyes, disperse dyes, ingrain dyes, vat dyes, metal complex dyes, reactive dyes, acid dyes, sulfur dyes, coupling dyes or substantive dyes.

With particular preference the coating material used in accordance with the invention comprises at least one anticorrosion pigment, among which nanoparticulate silicon dioxide is preferred (see also below).

The above-described components which may be present in the coating material used in accordance with the invention, processes for preparing them, and suitable amounts for use in each case, are described in more detail in “Lackadditive” by Johan Bieleman, Wiley-VCH, Weinheim, N.Y., 1998, in DE 199 14 896 A1 or in WO 2008/151997, hereby incorporated in full by reference.

On account of the good binder properties of the polymers and oligomers used in accordance with the invention, however, it has emerged as being advantageous to use them as binders in anticorrosion formulations, more particularly in anticorrosion pigment formulations.

In such anticorrosion formulations, as already stated, the polymers and oligomers employed in accordance with the invention are a full or partial replacement for the customary binders (examples being those based on acrylic acid or on acrylate, e.g., styrene/acrylic acid copolymers) and, on account of their own corrosion control properties, enhance the corrosion control effect of such formulations, and of the coatings produced therewith, to a significant degree.

The polymers and oligomers used in accordance with the invention are preferably employed in anticorrosion pigment formulations, more preferably in those with oxidic pigments. Preferred oxidic pigments are selected from SiO₂, TiO₂, ZnO, and BaTiO₃ pigments, and more preferably from SiO₂ pigments.

The invention accordingly further provides anticorrosion compositions comprising
(a) at least one highly branched polymer and/or at least one oligomer as defined above; and
(b) at least one anticorrosion pigment selected from silicon dioxide, titanium dioxide, zinc(II) oxide, and barium titanate (BaTiO₃), and being preferably an SiO₂ pigment.

The oxidic pigments are preferably nanoparticulate. Nanoparticulate in this context means that none of the dimensions of such particles exceeds 100 nm. Nanoparticulate oxidic pigments are known and available commercially, in the form, for example, of Aerosil® 200 from Evonik (silicon dioxide particles having an average size of 12 nm and a BET surface area of 170+1-125 m²/g) or Ludox CL-P from Grace (colloidal silica dispersion).

The anticorrosion composition of the invention may further comprise at least one of the aforementioned optional components for coating materials. Preferably, however, it comprises no further binder and also no further anticorrosion pigment.

The above-described coating materials and primarily the anticorrosion composition of the invention are also suitable for application in a coil coating process. Coil coatings are coatings on rolled metal strips which, following production, are wound up into rolls (called coils) for storage and transportation. These metal strips constitute the starting material for the majority of sheetlike metallic workpieces, examples being automobile parts, bodywork parts, instrument panels, façade panels, ceiling panels or window profiles. For these purposes, the suitable metal sheets are shaped by means of appropriate techniques such as punching, drilling, folding, profiling and/or deep drawing. By coil coating process is meant the continuous coating of metal strips with usually liquid coating materials. Metal strips with a thickness of 0.2 to 2 mm and a width or up to 2 m are transported at a speed of up to 200 m/min through a coil coating line, and are coated in the process. For this purpose it is possible, for example, to use cold-rolled strips of soft steels or construction-grade steels, electrolytically galvanized thin sheet, hot-dip-galvanized steel strip, or strips of aluminum or aluminum alloys. Typical lines comprise a feed station, a strip store, a cleaning and pretreatment zone, a first coating station along with baking oven and downstream cooling zone, a second coating station with oven, laminating station, and cooling, and a strip store and winder. Characteristic of coil coatings are thin coats of the coating materials, which have a dry film thickness of usually well below 80 μm, often below 60 μm, below 50 μm, and even below 40 μm. Moreover, the metal sheets are processed with a high throughput, necessitating short residence times; in other words, necessitating drying at elevated temperature following application of the coating, in order to make the coating material durable quickly.

The polymers or oligomers used in accordance with the invention produce anticorrosion compositions which are employed in corrosiveness categories C2 (in accordance with DIN EN ISO 12944) or higher, preferably in corrosiveness categories C3 or higher, and more preferably in corrosiveness categories C4 or higher.

These corrosiveness categories to DIN EN ISO 12944, based on the mass loss per unit area or on the thickness reduction after the first year of exposed storage, are defined as follows for unalloyed steel and for zinc:

| | | |
|---|---|---|
| C2 (low corrosivity): | unalloyed steel: | mass loss >10-200 g/m² |
| | | thickness decrease >1.3-25 μm |
| | zinc: | mass loss >0.7-5 g/m² |
| | | thickness decrease >0.1-0.7 μm |
| C3 (medium | unalloyed steel: | mass loss >200-400 g/m² |
| corrosivity): | | thickness decrease >25-50 μm |
| | zinc: | mass loss >5-15 g/m² |
| | | thickness decrease >0.7-2.1 μm |
| C4 (high corrosivity): | unalloyed steel: | mass loss >400-650 g/m² |
| | | thickness decrease >50-80 μm |
| | zinc: | mass loss >15-30 g/m² |
| | | thickness decrease >2.1-4.2 μm |
| C5-I/M (very high): | unalloyed steel: | mass loss >650-1500 g/m² |
| | | thickness decrease >80-200 μm |
| | zinc: | mass loss >30-60 g/m² |
| | | thickness decrease >4.2-8.4 μm |

On account of their good binder properties and high level of adhesion to corrosion-threatened materials, more particularly metals, the polymers and oligomers used in accordance with the invention are also suitable for use in electrochemical coating, especially in cathodic dip coating (cathaphoresis), where they may be a partial or complete replacement for the phosphating step.

In the electrochemical deposition process, the product for painting (i.e., the material to be coated) is immersed into an electrically conductive, aqueous deposition coating material, and a direct voltage field is applied between product for painting and a counterelectrode. Particles present in the deposition coating material, e.g., binders, are precipitated on the surface of the product for painting, which is connected as an electrode, and so form a continuous, adhering paint film. In the case of cathodic deposition coating, the product for painting is connected as the cathode. Customary deposition coating processes perform a phosphating step prior to the electrochemical coating operation itself. With phosphating (also called Bonderizing or Parkerizing), a layer known as a conversion coat, comprising firmly adhering metal phosphates, is formed by chemical reaction of a metallic surface with aqueous phosphate solutions. The phosphate layer adheres very effectively to the substrate and, as a result of the microporous or micro-capillary layer structure, permits effective anchoring of subsequent coatings. In addition, it hinders rust creep at damaged sites on the coating. A disadvantage associated with phosphating is that it is usually carried out using heavy metal phosphates, such as iron, zinc or manganese phosphate, and this makes it complicated and expensive to dispose of the wastewaters.

It has now emerged that the above-described polymers and oligomers can wholly or partly replace the phosphates, and form layers with similarly effective adhesion and with comparable or even better corrosion control properties.

For this purpose, the polymer or oligomer is deposited either by simply dipping the substrate to be coated into a solution comprising the polymers, or by application of a voltage, on the substrate surface. The remaining process steps may then be carried out as in conventional electrochemical dipping processes.

Through the use of the above-described polymers and oligomers in the electrochemical dipping process, and especially in the case of cathodic dip processes, the disposal problems affecting the phosphate-containing wastewaters are reduced.

The above-described polymers and oligomers combine a number of properties that are of key importance for corrosion control, and are therefore distinguished by diverse possibilities for use in corrosion control.

The invention is now illustrated further by the nonlimiting examples below.

### EXAMPLES

The amine number was determined in accordance with DIN 53176.

### 1. Preparation of Highly Branched Polymers

1.1 Preparation of a Polymer from Melamine, Hexamethylenediamine, and Tetraethylenepentamine

In a 4 I four-neck flask with metal stirrer, reflux condenser, heating jacket, and line out to a waste-gas scrubber filled with sulfuric acid, hexamethylenediamine (589.1 g, 5.07 mol) and tetraethylenepentamine (533.9 g, 2.82 mol) were mixed under a stream of nitrogen and admixed with ethylene glycol (500 ml). Then phosphoric acid (48.4 g, 0.49 mol) was added dropwise and phosphorous acid (69.7 g, 0.85 mol) was added, and the mixture was heated to 50° C. A third of the total amount of melamine used (total amount: 355.7 g, 2.82 mol; addition of approximately 118.5 g per portion) was added, and the mixture was heated to 180° C., whereupon ammonia was evolved. After 4 hours, the second melamine portion was added, and after a further 4 hours the third and final melamine portion was added, and the mixture was heated at 180° C. for a further 30 hours. Removal of the solvent gave a pale yellow product, which was diluted with water to form a 50% strength solution.

The properties of the product were as follows:

Mₙ: 9100; M_{w}: 23 000; PD: 2.5 (GPC in hexafluoroisopropanol).

Amine number: 387 mg KOH/g

1.2 Preparation of a Polymer from Melamine, Hexamethylenediamine, and N4 Amine

In a 4 I four-neck flask with metal stirrer, reflux condenser, heating jacket, and line out to a waste-gas scrubber filled with sulfuric acid, hexamethylenediamine (836.64 g, 7.2 mol) and N4 amine (697.20 g, 4.0 mol) were mixed under a stream of nitrogen and admixed with ethylene glycol (500 ml). Then phosphoric acid (254.8 g, 2.6 mol) was added dropwise and phosphorous acid (98.4 g, 1.2 mol) was added, and the mixture was heated to 75° C. A seventh of the total amount of melamine used (total amount: 504.48 g, 4.0 mol; addition of 72.07 g per portion) was added, and the mixture was heated to 180° C., whereupon ammonia was evolved. The further portions of melamine were added every 2 hours. When all of the melamine had dissolved, the mixture was heated at 180° C. for a further 35 hours. Removal of the solvent gave a hard, yellow, water-soluble product.

The properties of the product were as follows:

Mₙ: 5500; M_{w}: 25 000; PD: 4.6 (GPC in hexafluoroisopropanol).

Amine number: 326 mg KOH/g

### 2. Performance Examples

### 2.1 Use as Binders in Formulations of Oxidic Nanoparticles

The polymers from Examples 1.1 and 1.2 were dissolved in water at a temperature of 60° C., at a suitable concentration to form 10% strength by weight solutions in each case. The pH was adjusted using phosphoric acid to 5 to 6.

For comparison, a 50% dispersion of a styrene/acrylic acid copolymer (Acronal® S 760 from BASF SE) was used.

With addition of oxidic nanoparticles (either silicon dioxide particles (Aerosil® 200 from Evonik) or colloidal silicon dioxide dispersion (Ludox® CL-P from Grace)), dipping baths were prepared from the three polymer solutions, the composition of the baths being set out in Table 1.

TABLE 1
Composition of the dipping baths

| | | SC of | | | |
|---|---|---|---|---|---|
| | | polymer | Aerosil 200 | Ludox CL-P | Water |
| Example | Polymer | [%] | SC [%] | SC [%] | [%] |
| 1 | from Ex. 1.1 | 2.5 | — | — | 97.5 |
| 2 | from Ex. 1.1 | 5 | — | — | 95 |
| 3 | from Ex. 1.1 | 2.5 | 1 | — | 96.5 |
| 4 | from Ex. 1.1 | 2.5 | — | 1 | 96.5 |
| 5 | — | — | 1 | — | 99 |
| 6 | from Ex. 1.2 | 2.5 | — | — | 97.5 |
| 7 | from Ex. 1.2 | 5 | — | — | 95 |
| 8 | from Ex. 1.2 | 2.5 | 1 | — | 96.5 |
| 9 | from Ex. 1.2 | 2.5 | — | 1 | 96.5 |
| 10 | Acronal ® * | 5 | 1 | — | 94 |
| 11 | Acronal ® * | 10 | 1 | — | 89 |
| 12 | Acronal ® * | 20 | 1 | — | 79 |
| 13 | Acronal ® * | 20 | — | — | 80 |

* Acronal ® S 760 from BASF SE

Testing took place by immersing the substrates into the dipping bath, and subsequently subjecting the substrates thus coated to corrosion tests.

Substrates used were steel panels (Gardobond® OC from Chemetall) and galvanized steel panels (Gardobond® OMBZ; electrolytically galvanized steel sheets from Chemetall) with a size of 10.5×19 cm.

The dipping operation is carried out following alkaline cleaning of the test panels, followed by a rinsing step by full immersion of the panels at 50° C. After a residence time of 3 minutes, the panels, after being lifted out and allowed to run off over the edge of the test panels, were dried in a drying oven at 60° C.

Two panels each were tested in the EN ISO 6270-2: 2005 climatic test (20 cycles) and in the DIN 50017 salt spray test.

In the case of testing in the salt chamber, for the steel panels (without cathodic deposition coating), the time taken for corrosion (red rust) to appear is recorded, and an evaluation is made in accordance with the rust index RI to ISO 10289 after 6 hours. In the case of the electrolytically galvanized panels, the rust index RI was determined after 3 days in the salt chamber. The degree of evaluation for the rust index in accordance with ISO 10289 is set out in Table 2.

A third panel, following removal from the dipping bath, was briefly immersed in a rinsing bath (fully demineralized water), and immediately thereafter a cathodic electrocoat material was applied, with a film thickness of 20+/−3 μm. A scored scribe mark was made in these panels, and they were subjected to the salt spray test of EN ISO 9227:2006. Evaluation took place, in accordance with EN ISO 9227:2006, by a determination of the sub-film corrosion migration (creep) at the scribe mark. For this purpose, following storage in the salt spray chamber, all of the loose areas were removed completely using a scraper blade, and the exposed gap or exposed defects were measured (in mm of width).

The results are set out in Table 3.

TABLE 2
Rust index RI according to ISO 10289

| | Degree of evaluation |
|---|---|
| Defect area % | R_{β} or R_{α} |
| no defect | 10 |
| 0 < A ≦ 0.25 | 9 |
| 0.25 < A ≦ 0.5 | 8 |
| 0.5 < A ≦ 1.0 | 7 |
| 1.0 < A ≦ 2.5 | 6 |
| 2.5 < A ≦ 5.0 | 5 |
| 2.5 < A ≦ 5.0 | 5 |
| 5.0 < A ≦ 10 | 4 |
| 10 < A ≦ 25 | 3 |
| 25 < A ≦ 50 | 2 |
| 50 < A ≦ 75 | 1 |
| 75 < A | 0 |

TABLE 3
Results of the corrosion tests for Examples 1 to 13

| | | RI 2-time | | | | | |
|---|---|---|---|---|---|---|---|
| | | to corrosion | | | | UR 6 | UR 7 |
| Example | RI 1 | [h] | RI 3 | RI 4 | RI 5 | [mm] | [mm] |
| 1 | 1-2 | 1 | 2 | 3-4 | 3 | 2.9 | 2.7 |
| 2 | 2-3 | 1 | 2-3 | 4 | 3-4 | 2.7 | 2.7 |
| 3 | 4 | 4 | 5 | 6 | 4-5 | 1.8 | 2.0 |
| 4 | 4 | 1.5 | 2 | 6 | 4 | | |
| 5 | 0 | 0.1 | 1 | 2-3 | 2 | 4.8 | 3.9 |
| 6 | 2 | 1 | 2 | 3 | 3-4 | 3.1 | 2.9 |
| 7 | 2 | 1 | 3 | 3-4 | 4 | 2.6 | 2.3 |
| 8 | 3-4 | 4-5 | 4 | 5 | 4 | 2.4 | 2.2 |
| 9 | 4 | 5 | 4 | 4-5 | 4 | 1.9 | 1.8 |
| 10 | 1-2 | 0.5 | 2 | 2-3 | 2-3 | 3.3 | 2.7 |
| 11 | 2 | 0.5 | 2-3 | 3 | 2-3 | 2.9 | 2.9 |
| 12 | 2 | 1 | 3 | 3-4 | 3 | 2.8 | 3.1 |
| 13 | 1-2 | 1 | 2-3 | 3 | 3 | 3.6 | 3.4 |

RI 1 RI after climatic cycling test; steel panel
RI 2 RI after salt spray test, steel panel
RI 3 RI after salt spray test (6 h), steel panel
RI 4 RI after climatic cycling test, galvanized steel panel
RI 5 RI after salt spray test (72 h), galvanized steel panel
UR 6 scribe creep, DIN; steel panel
UR 7 scribe creep, DIN; galvanized steel panel

1. The use of condensation products selected from
(i) highly branched polymers obtainable by the condensation of
(i-1) melamine and/or at least one melamine derivative; and
(i-2) at least one amine having at least two primary amino groups that is different from melamine and from said at least one melamine derivative; and
(i-3) optionally at least one further amine, which is different from components (i-1) and (i-2);
(ii) highly branched polymers obtainable by the condensation of
(ii-1) urea and/or at least one urea derivative; and
(ii-2) at least one amine having at least two primary and/or secondary amino groups, with at least one amine necessarily comprising at least three primary and/or secondary amino groups; and
(ii-3) optionally at least one further amine, which is different from component (ii-2);
(iii) highly branched polymers obtainable by the condensation of
(iii-1) melamine and/or at least one melamine derivative;
(iii-2) urea and/or at least one urea derivative; and
(iii-3) at least one amine having at least two primary amino groups that is different from melamine and from said at least one melamine derivative; and
(iii-4) optionally at least one further amine, which is different from components (iii-1) and (iii-3);
(iv) oligomeric compounds, obtainable by the condensation of
(iv-1) melamine and/or at least one melamine derivative; and
(iv-2) at least one amine having at least two primary amino groups that is different from melamine and from said at least one melamine derivative; and
(iv-3) optionally at least one further amine, which is different from components (iv-1) and (iv-2);
(v) oligomeric compounds, obtainable by the condensation of
(v-1) urea and/or at least one urea derivative; and
(v-2) at least one amine having at least two primary and/or secondary amino groups, with at least one amine necessarily comprising at least three primary and/or secondary amino groups; and
(v-3) optionally at least one further amine, which is different from component (v-2); and
(vi) oligomeric compounds, obtainable by the condensation of
(vi-1) melamine and/or at least one melamine derivative;
(vi-2) urea and/or at least one urea derivative; and
(vi-3) at least one amine having at least two primary amino groups that is different from melamine and from said at least one melamine derivative; and
(vi-4) optionally at least one further amine, which is different from components (vi-1) and (vi-3);
for reducing or preventing the corrosion of corrosion-threatened materials.

2. The use according to claim 1, as anticorrosion composition or as corrosion inhibitor.

3. The use according to claim 2, as anticorrosion composition.

4. The use according to claim 1, as binder in anticorrosion pigment formulations.

5. The use according to any of the preceding claims, said corrosion-threatened materials being metals.

6. The use according to claim 5, said metals being selected from iron, iron alloys, zinc, and aluminum.

7. The use according to any of the preceding claims, where said at least one amine having at least two primary and/or secondary amino groups, of components (i-2), (ii-2), (iii-3), (iv-2), (v-2), and (vi-3), is selected from amines of the formula I
NH₂-A-NH₂ (I)
wherein
A is a divalent aliphatic, alicyclic, aliphatic-alicyclic, aromatic or araliphatic radical, with the aforementioned radicals also possibly being interrupted by a carbonyl group or by a sulfone group and/or possibly substituted by 1, 2, 3 or 4 radicals selected from C₁-C₄-alkyl; or is a divalent radical of the formula
B—Xₘ—B—
in which
each X independently is O or NR^{c}, in which R^{c} is H, C₁-C₄-alkyl, C₂-C₄-hydroxyalkyl or C₁-C₄-alkoxy;
each B independently is C₂-C₆-alkylene; and
m is a number from 1 to 100.

8. The use according to claim 7, wherein the divalent aliphatic radicals A are selected from linear and branched C₂-C₂₀-alkylene.

9. The use according to claim 7, wherein the divalent alicyclic radicals A are selected from C₅-C₈-cycloalkylene which may carry 1, 2, 3 or 4 C₁-C₄-alkyl radicals.

10. The use according to claim 7, wherein the divalent aliphatic-alicyclic radicals A are selected from C₅-C₈-cycloalkylene-C₁-C₄-alkylene, C₅-C₈-cycloalkylene-C₁-C₄-alkylene-C₅-C₈-cycloalkylene and C₁-C₄-alkylene-C₅-C₈-cycloalkylene-C₁-C₄-alkylene, with the cycloalkylene radicals possibly carrying 1, 2, 3 or 4 C₁-C₄-alkyl radicals.

11. The use according to claim 7, wherein the divalent aromatic radicals A are selected from phenylene, naphthylene, biphenylene, phenylene-sulfone-phenylene, and phenylene-carbonyl-phenylene, with the phenylene radicals possibly carrying 1, 2, 3 or 4 C₁-C₄-alkyl radicals.

12. The use according to claim 7, wherein the divalent araliphatic radicals A are selected from phenylene-C₁-C₄-alkylene and phenylene-C₁-C₄-alkylene-phenylene, with the phenylene radicals possibly carrying 1, 2, 3 or 4 C₁-C₄-alkyl radicals.

13. The use according to claim 7, wherein A is linear and branched C₂-C₂₀-alkylene or is a divalent radical of the formula
B—Xₘ—B—
in which B, X, and m are as defined in claim 7.

14. The use according to either of claims 7 and 13, in which
each X independently is NR^{c}, in which R^{c} is H, C₁-C₄-alkyl, C₂-C₄-hydroxyalkyl or C₁-C₄-alkoxy, and preferably is H;
each B independently is C₂-C₃-alkylene; and
m is a number from 1 to 20, preferably 1 to 6.

15. The use according to any one of the preceding claims, wherein said at least one amine having at least three primary and/or secondary amino groups, of components (ii-2) and (v-2) is selected from
amines of the formula I.a
NHR^{a1}-A¹-NHR^{b1} (I.a)
in which
A¹ is a divalent radical of the formula
B¹—X¹ₘ₁—B¹—
in which
each X¹ independently is O or NR^{c1}, with at least one X¹ in the compound I.a being NR^{c1}, in which Rd is H, C₁-C₄-alkyl, C₂-C₄-hydroxyalkyl or C₁-C₄-alkoxy, with at least one radical R^{c1} being H;
each B¹ independently is C₂-C₆-alkylene; and
m¹ is a number from 1 to 20; and
R^{a1} and R^{b1} independently of one another are H, C₁-C₄-alkyl, C₂-C₄-hydroxyalkyl or C₁-C₄-alkoxy;
amines of the formula II 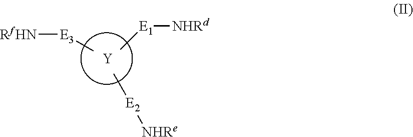
in which
Y is CR^{g}, N, C₂-C₆-cycloalkyl, phenyl or a 5- or 6-membered, saturated, partly unsaturated or aromatic heterocyclic ring having 1, 2 or 3 heteroatoms as ring members which are selected from N, O, and S;
E₁, E₂, and E₃ independently of one another are a single bond, C₁-C₁₀-alkylene, NR^{h}—C₂-C₁₀-alkylene or O—C₁-C₁₀-alkylene, with the proviso that E₁, E₂, and E₃ are not a single bond and not NR^{h}—C₂-C₁₀-alkylene if Y is N;
R^{d}, R^{e} and R^{f} independently of one another are H, C₂-C₄-hydroxyalkyl or C₁-C₄-alkoxy; and
R^{g} and R^{h} independently of one another are H, C₂-C₄-hydroxyalkyl or C₁-C₄-alkoxy;
amines of the formula III 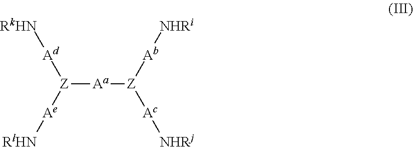
in which
A^{a} has one of the definitions stated for A in any one of claims 5 to 11;
A^{b}, A^{c}, A^{d}, and A^{e} independently of one another are C₁-C₁₀-alkylene;
Z is N or CR^{m}; and
Rⁱ, R^{j}, R^{k}, R^{l}, and R^{m} independently of one another are H, C₂-C₄-hydroxyalkyl or C₁-C₄-alkoxy; and
mixtures thereof.

16. The use according to any of the preceding claims, wherein the highly branched polymers (i) are obtainable by the condensation of
(i-1a) melamine, optionally in a mixture with at least one melamine derivative;
(i-2a) optionally at least one amine of the formula I as defined in claim 7, in which A is linear or branched C₂-C₂₀-alkylene;
(i-2b) at least one amine of the formula I as defined in claim 7, in which A is a divalent radical of the formula
B—Xₘ—B—
in which B, X, and m are as defined in either of claims 7 and 14; and
(i-3) optionally at least one amine having a primary amino group and/or at least one amine having at least three primary amino groups, which is different from melamine and from the at least one melamine derivative.

17. The use according to claim 16, wherein the highly branched polymers (i) are obtainable by the condensation of
(i-1a) melamine, optionally in a mixture with at least one melamine derivative;
(i-2a) at least one amine of the formula I as defined in claim 7, in which A is linear or branched C₂-C₂₀-alkylene;
(i-2b) at least one amine of the formula I as defined in claim 7, in which A is a divalent radical of the formula
in which B, X, and m are as defined in either of claims 7 and 14; and
(i-3) optionally at least one amine having a primary amino group and/or at least one amine having at least three primary amino groups, which is different from melamine and from the at least one melamine derivative.

18. The use according to either of claims 16 and 17, wherein said at least one amine having at least three primary amino groups, of component (i-3), is selected from amines of the formula II and III as defined in claim 15.

19. The use according to any of the preceding claims, wherein the urea derivatives of components (ii-1), (iii-2), (v-1), and (vi-2) are selected from
a. substituted ureas of the formula R¹R²N—C(═O)—NR³R⁴, in which R¹, R², R³, and R⁴ independently of one another are selected from hydrogen, C₁-C₁₂-alkyl, aryl, and aryl-C₁-C₄-alkyl, with at least one of the radicals R¹, R², R³, and R⁴ not being hydrogen; or R¹ and R² and/or R³ and R⁴ each together are C₂-C₅-alkylene, with one methylene group optionally being replaced by a carbonyl group; or R¹ and R³ together are C₂-C₅-alkylene, with one methylene group optionally being replaced by a carbonyl group; or R¹ and R² and/or R³ and R⁴, in each case together with the nitrogen atom to which they are attached, form a 5- or 6-membered unsaturated aromatic or nonaromatic ring which may further comprise one or two further nitrogen atoms or a sulfur atom or oxygen atom as ring member;
b. biuret;
c. thiourea;
d. substituted thioureas of the formula R⁵R⁶N—C(═S)—NR⁷R⁸, in which R⁵, R⁶, R⁷, and R⁸ independently of one another are selected from hydrogen, C₁-C₁₂-alkyl, aryl, and aryl-C₁-C₄-alkyl, with at least one of the radicals R⁵, R⁶, R⁷, and R⁸ not being hydrogen; or R⁵ and R⁸ and/or R⁷ and R⁸ each together are C₂-C₅-alkylene, with one methylene group optionally being replaced by a carbonyl group; or R⁵ and R⁷ together are C₂-C₅-alkylene, with one methylene group optionally being replaced by a carbonyl group; or R⁵ and R⁶ and/or R⁷ and R⁸, in each case together with the nitrogen atom to which they are attached, form a 5- or 6-membered unsaturated aromatic or nonaromatic ring which may further comprise one or two further nitrogen atoms or a sulfur atom or oxygen atom as ring member;
e. guanidine or a guanidine salt;
f. substituted guanidines of the formula R⁹R¹⁰N—C(═NR¹¹)—NR¹²R¹³, in which R⁹, R¹⁰, R¹¹, R¹², and R¹³ independently of one another are selected from hydrogen, C₁-C₁₂-alkyl, aryl, and aryl-C₁-C₄-alkyl, with at least one of the radicals R⁹, R¹⁰, R¹¹, R¹², and R¹³ not being hydrogen; or R⁹ and R¹⁰ and/or R¹² and R¹³ each together are C₂-C₅-alkylene, with one methylene group optionally being replaced by a carbonyl group; or R⁹ and R¹² together are C₂-C₅-alkylene, with one methylene group optionally being replaced by a carbonyl group; or R⁹ and R¹⁰ and/or R¹² and R¹³, in each case together with the nitrogen atom to which they are attached, form a 5- or 6-membered unsaturated aromatic or nonaromatic ring which may further comprise one or two further nitrogen atoms or one sulfur atom or oxygen atom as ring member; and
g. carbonic esters of the formula R¹⁴—O—CO—O—R¹⁵, in which R¹⁴ and R¹⁵ independently of one another are selected from C₁-C₁₂-alkyl, aryl, and aryl-C₁-C₄-alkyl, or R¹⁴ and R¹⁵ together are C₂-C₅-alkylene.

20. The use according to claim 19, wherein R² and R⁴ are hydrogen and R¹ and R³ are alike and are C₁-C₁₂-alkyl, aryl or aryl-C₁-C₄-alkyl; or R¹, R², R³, and R⁴ are alike and are linear C₁-C₄-alkyl; or R¹ and R² and also R³ and R⁴, in each case together, are C₂-C₅-alkylene, with one methylene group optionally being replaced by a carbonyl group; or R² and R⁴ are hydrogen and R¹ and R³ together are C₂-C₅-alkylene, with one methylene group optionally being replaced by a carbonyl group; or R¹ and R² and also R³ and R⁴, in each case together with the nitrogen atom to which they are attached, form a 5- or 6-membered unsaturated aromatic or nonaromatic ring which may further comprise a further nitrogen atom, sulfur atom or oxygen atom as ring member.

21. The use according to claim 19, wherein R⁶ and R⁸ are hydrogen and R⁵ and R⁷ are alike and are C₁-C₁₂-alkyl, aryl or aryl-C₁-C₄-alkyl; or R⁵, R⁶, R⁷, and R⁸ are alike and are linear C₁-C₄-alkyl; or R⁵ and R⁶ and also R⁷ and R⁸, in each case together, are C₂-C₅-alkylene, with one methylene group optionally being replaced by a carbonyl group; or R⁶ and R⁸ are hydrogen and R⁵ and R⁷ together are C₂-C₅-alkylene, with one methylene group optionally being replaced by a carbonyl group; or R⁵ and R⁶ and also R⁷ and R⁸, in each case together with the nitrogen atom to which they are attached, form a 5- or 6-membered unsaturated aromatic or nonaromatic ring which may further comprise a further nitrogen atom, sulfur atom or oxygen atom as ring member.

22. The use according to claim 19, wherein R¹⁰, R¹¹, and R¹³ are hydrogen and R⁹ and R¹² are alike and are C₁-C₁₂-alkyl, aryl or aryl-C₁-C₄-alkyl; or R⁹, R¹⁰, R¹² and R¹⁴ are alike and are linear C₁-C₄-alkyl and R¹¹ is H or methyl; or R⁹ and R¹⁰ and also R¹² and R¹³ in each case together are C₂-C₅-alkylene, with one methylene group optionally being replaced by a carbonyl group, and R¹¹ is H or methyl; or R¹⁰, R¹¹, and R¹³ are hydrogen and R⁹ and R¹² together are C₂-C₅-alkylene, with one methylene group optionally being replaced by a carbonyl group; or R⁹ and R¹⁰ and also R¹² and R¹³, in each case together with the nitrogen atom to which they are attached, form a 5- or 6-membered unsaturated aromatic or nonaromatic ring which may further comprise a further nitrogen atom, sulfur atom or oxygen atom as ring member, and R¹¹ is H or methyl.

23. The use according to claim 19, wherein R¹⁴ and R¹⁵ are alike and are C₁-C₄-alkyl.

24. The use according to any of the preceding claims, wherein use is made as components (ii-1), (iii-2), (v-1), and (vi-2) of urea, at least one substituted urea of the formula R¹R²N—C(═O)—NR³R⁴, guanidine or a guanidine salt, in which R¹, R², R³, and R⁴ independently of one another are as defined in either of claims 19 and 20.

25. The use according to any of the preceding claims, wherein the melamine derivative of components (i-1), (iii-1), (iv-1), and (vi-1) is selected from benzoguanamine, substituted melamines, and melamine condensates.

26. The use according to any of the preceding claims, wherein use is made as components (i-1), (iii-1), (iv-1), and (vi-1) of melamine.

27. The use according to any of the preceding claims, wherein the condensation for preparing the polymers or compounds (i), (ii), (iii), (iv), (v), and (vi) takes place in the absence of halogen-containing compounds.

28. The use according to any of the preceding claims, wherein the condensation for preparing the polymers or compounds (i), (ii), (iii), (iv), (v), and (vi) takes place in the absence of a catalyst or using a halogen-free mineral acid catalyst.

29. The use according to claim 28, wherein the condensation for preparing the polymers or compounds (i), (ii), (iii), (iv), (v), and (vi) takes place using phosphoric acid and/or phosphorous acid.

30. A method for reducing, retarding or preventing the corrosion of corrosion-threatened materials, in which the materials and/or the corrosive medium to which the materials are exposed are or is contacted with at least one of the highly branched polymers and/or oligomers as defined in any of the preceding claims.

31. The method according to claim 30, wherein the corrosion-threatened materials are coated with at least one highly branched polymer and/or at least one oligomer as defined in any of claims 1 to 29.

32. An anticorrosion composition comprising
(a) at least one highly branched polymer and/or at least one oligomer as defined in any of claims 1 to 29; and
(b) at least one anticorrosion pigment selected from silicon dioxide, titanium dioxide, zinc(II) oxide, and barium titanate.
